(19) United States
(12) Patent Application Publication
(10) Pub. No.: US 2013/0204765 A1
(43) Pub. Date: Aug. 8, 2013

(54) METHOD AND SYSTEM OF TRADING A SECURITY IN A FOREIGN CURRENCY

(71) Applicant: Richard Seoh Leng Koh, Singapore (SG)

(72) Inventor: Richard Seoh Leng Koh, Singapore (SG)

(73) Assignee: M-DAQ PTE LTD, Singapore (SG)

(21) Appl. No.: 13/809,567

(22) PCT Filed: Jul. 11, 2011
(86) PCT No.: PCT/SG2011/000249

§ 371 Date: Mar. 25, 2013

(30) Foreign Application Priority Data
Jul. 13, 2010 (SG) PCT/SG2010/000262

(51) Int. Cl. G06Q 40/04

(52) U.S. Cl. CPC G06Q 40/04
USPC 705/37

(57) ABSTRACT

A system and method for trading a security in a foreign currency. The system comprising: an FX pricing module for maintaining FX data streamed from one or more liquidity providers; and a market manager module configured to receive original trade data associated with the security in a trading currency of the security and to generate converted trade data associated with the security in the foreign currency; wherein the market manager module generates the converted trade data based on an FX rate provided by the FX pricing module.

### FIELD OF INVENTION

The invention relates to a method and system of trading a security in a foreign currency.

### BACKGROUND

An investor who wishes to trade on a security in a non-native Exchange will be required to perform a currency conversion (i.e. Foreign Exchange or FX) as all Exchanges currently offer stock quotes in local currency (LCY) only. For example, a US Dollar-based investor wanting to buy a particular company's stock on the Singapore Exchange (SGX), which is quoted only in Singapore Dollars, will have to perform a US Dollar-Singapore Dollar FX. In other words, a foreign currency (FCY) based investor has limited direct access to LCY-quoted products.

Currently, a broker can assist the investor in the purchase or sale of the security. At the same time, the broker can handle the FX conversion for the investor on a post trade basis. In other words, the FX conversion takes place after the securities trade has been successfully executed. At the point of execution of the securities trade, no imputing of the level of FX rates is done. Therefore, determination of the actual profit or loss (in native currency) by the investor can only be known after the FX transaction is completed.

In other words, the investor is exposed to FX Risks if he inputs a Buy Order in a Foreign Exchange. He might end up paying more than expected if the FX Rate moves against him. Likewise, if an investor inputs a Sell Order in a Foreign Exchange, he might end up receiving less than expected if the FX Rate moves against him.

If the broker attempts to “front run”, wherein a FX transaction is carried out before the purchase of a security, there is a likelihood of ‘slippage’. This ‘slippage’ occurs because the broker is typically unable to execute a FX transaction in the exact amount due to the uncertainty in price fluctuations of the security. As a result, there is either an excess or insufficient amount of foreign currency when trading the security.

Currently, during a foreign stock investment trade, 4 main entities are involved: an Exchange, a broker, an investor and a FX Liquidity Provider (e.g. a FX bank). The Exchange distributes market data (e.g. current best Bid/Offer and Last Traded Price) and the market data is received by the broker, whom in turn distributes the market data to the investor. If the investor decides to make a trade, he can place an order with the broker, and provide instructions such as the symbol of the security, whether to buy or sell the security and the quantity to be bought or sold. The broker places the order on behalf of the investor with the Exchange and the order is queued. In addition to the information regarding the symbol of the security, whether to buy or sell the security and the quantity to be bought or sold; the time that the order is placed is noted by the Exchange. If the order is matched, the Exchange notes information such as the symbol of the security, whether the security was bought or sold, the quantity that was bought or sold, the time that the order was matched and the status of the trade. The Exchange then notifies the broker of the execution of the order, whom in turn notifies the investor. After the investor acknowledges the execution of the order, he proceeds to request for a FX price from the FX Liquidity Provider. The investor provides the FX Liquidity Provider with information such as the currency pair, whether to buy or sell, and the quantity to be bought or sold. The FX Liquidity Provider quotes a FX price to the investor, providing information such as FX Quote ID and FX price. If the investor accepts the FX price, the latter is informed and the FX Quote ID and Accept status is relayed to the FX Liquidity Provider and the FX order is executed.

Currently, as described above, when an investor deals with a broker, for example, through an online system or through voice broking, the broker performs the FX conversion on a post trade basis at carted rates, typically ranging from 50-80 bps, compared to Interbank FX rates that usually range from 1-3 bps. In the institutional space, Fund Managers are typically able to source for FX rates ranging from 3-5 bps, either through their internal FX desks or via their parent banks. Fund Managers have the fiduciary duty to secure the best FX rate for the fund that they are managing, notwithstanding that this Fund Manager may be owned by a FX Bank. Such a process requires the need to source for competitive FX quotes (usually from 3-5 banks) and maintain an audit trail of such proof of Best Execution. Again, these activities are done on a post trade basis. As such, overseas retail investors often trade with an unknown, inaccurate and/or high FX conversion cost.

Due to the above disadvantages, interest in counters listed in non-native Exchanges are usually dampened due to the uncertainty on the FX conversion, resulting in many investors avoiding investing in securities that are denominated in a foreign currency. Overseas investors are further discouraged from trading in a security in a non-native Exchange in an environment of high FX volatility.

Some online brokers provide a “one-click” post-securities-trading FX conversion system. However, this is done on a post trade basis and at a private price rather than at an Exchange price. On the other hand, other online brokers provide investors with an open view of FX prices from different banks. However, these platforms are for currency trading. There are no links to security trades in said systems.

A need therefore exists to provide a multi-denomination automated quotation system that seeks to address at least one of the abovementioned problems.

### SUMMARY

According to the first aspect of the present invention, there is provided a system for trading a security in a foreign currency comprising: an FX pricing module for maintaining FX data streamed from one or more liquidity providers; a market manager module configured to receive original trade data associated with the security in a trading currency of the security and to generate converted trade data associated with the security in the foreign currency, wherein the market manager module generates the converted trade data based on an FX rate provided by the FX pricing module; and an order manager module configured to receive an order for trading in the security in the foreign currency based on the converted trade data.

According to a second aspect of the present invention, there is provided a method for trading a security in a foreign currency comprising: maintaining, in a FX pricing module, FX data streamed from one or more liquidity providers; receiving, in a market manager module, original trade data associated with the security in a trading currency of the security and automatically generating, in the market manager module, converted trade data associated with the security in the foreign currency, wherein the market manager module automatically generates the converted trade data based on an FX rate provided by the FX pricing module, wherein the market manager module automatically generates the converted trade data based on an FX rate provided by the FX pricing module; and receiving, in an order manager module, an order for trading in the security in the foreign currency based on the converted trade data.

According to a third aspect of the present invention, there is provided a data storage medium having stored thereon computer program code means for instructing a computer system to execute a method for trading a security in a foreign currency as described herein.

### BRIEF DESCRIPTION OF THE DRAWINGS

Example embodiments of the invention will be better understood and readily apparent to one of ordinary skill in the art from the following written description, by way of example only, and in conjunction with the drawings, in which:

FIG. 1a is a flow chart illustrating the events that occur during a foreign stock investment trade in accordance with an embodiment of the invention.

FIG. 1b is a MTR stock performance chart in HK Dollars from 9 Jan. 2009 to 6 Jan. 2010.

FIG. 1c is the corresponding MTR stock performance chart of FIG. 1A converted into Australian Dollars based on the respective FX conversion rates.

FIG. 2 is a schematic diagram illustrating the interactions that occur between entities and application modules during a foreign stock investment trade, according to an embodiment of the present invention.

FIG. 3 is a schematic diagram illustrating the processes performed by an Order Manager during a “No Fill” condition when a Market Order is placed, according to an embodiment of the present invention.

FIG. 4 is a schematic diagram illustrating the processes performed by an Order Manager during a “Filled” condition when a Market Order is placed, according to an embodiment of the present invention.

FIG. 5 is a schematic diagram illustrating the processes performed by an FX Execution Manager, according to an embodiment of the present invention.

FIG. 6 is a flow chart illustrating the events that occur during a Limit Order foreign stock investment trade in accordance with an embodiment of the invention.

FIG. 7 is a schematic diagram illustrating the processes performed by an Order Manager during a “No Fill” condition when a Limit Order (i.e. “No Worse Than” (NWT) Order) is placed, according to an embodiment of the present invention.

FIG. 8 is a schematic diagram illustrating the processes performed by an Order Manager during a “Filled” condition when a Limit Order (i.e. “No Worse Than” (NWT) Order) is placed, according to an embodiment of the present invention.

FIG. 9 is a screen capture of a graphical user interface (GUI) provided to FX banks, according to an embodiment of the present invention.

FIG. 10 is a flowchart illustrating the workflow in a foreign stock investment trade using the Rule-Based Automated Threshold System (RATS), according to an embodiment of the present invention.

FIG. 11 is a schematic illustrating the filling and complete flushing of the cache on an aggregated basis, according to an embodiment of the present invention.

FIG. 12 is a schematic illustrating the filling and complete flushing of the cache on a netted basis, according to an embodiment of the present invention.

FIG. 13 is a schematic illustrating the filling and flushing of the cache at ±5% range of the stipulated threshold, according to an embodiment of the present invention.

FIG. 14 is a schematic illustrating the filling and flushing of the cache to get below the stipulated threshold, according to an embodiment of the present invention.

FIG. 15 is a flowchart illustrating the workflow in a foreign stock investment trade using a multi-denomination automated quotation (M-DAQ) platform comprising a Stop Loss/Opportunity Gain (SLOG) Re-pricer, according to an embodiment of the present invention.

FIG. 16 is a chart illustrating the re-pricing of a buy order depending on fluctuations of the FX rate, as described above, according to an embodiment of the present invention.

FIG. 17 is a chart illustrating the re-pricing of a sell order depending on fluctuations of the FX rate, as described above, according to an embodiment of the present invention.

FIG. 18 is a chart illustrating the re-pricing of a buy order depending on fluctuations of the FX rate, as described above, according to an embodiment of the present invention.

FIG. 19 is a chart illustrating the re-pricing of a sell order depending on fluctuations of the FX rate, as described above, according to an embodiment of the present invention.

FIG. 20 is a flow chart illustrating a method for trading a security in a foreign currency, according to an example embodiment of the present invention.

FIG. 21 is a schematic of a computer system for implementing the system and method for trading a security in a foreign currency in example embodiments.

### DETAILED DESCRIPTION

Embodiments of the present invention relate to multi-denomination automated quotation system that advantageously provides a platform to price and trade any exchange-traded product in more than one currency by blending ‘executable’ foreign exchange (FX) rates into equities and securities products. Embodiments of the present invention provide a paradigm shift that moves from a post-trade to a pre-trade model and can integrate with the quoting/trading platform of a National Stock or Securities Exchange so as to provide real-time market data distribution to the Exchange's market data system in foreign currencies. In addition, embodiments of the present invention may allow investors to place securities orders in a quoted foreign currency of their choice, and foreign currency denominated orders are converted into local currency for the Exchange to perform order queuing and matching on their current platform. Moreover, the best bid/offer among a number of FX quotes from liquidity providers (LPs) can be determined and applied when currency conversion takes place.

Embodiments of the present invention may further provide each LP with a tool to manage their FX trades and aggregation and may keep additional latency to the existing processes of market data distribution and order management to as minimal as possible—which is typically up to some microseconds. Embodiments of the present invention may also provide a single data field containing both Securities Trade (Parent) and FX Trades (Child) details where a One-to-Many and Many-to-One tracing can be done without the need for a data reconciliation process.

Embodiments of the present invention may be implemented via the real time, low latency, high frequency platforms such as Linux RT kernel, Java RTS, ULlink MD solution, In-memory Database etc.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a general purpose computer or other device selectively activated or reconfigured by a computer program stored in the computer. The algorithms and displays presented herein are not inherently related to any particular computer or other apparatus. Various general purpose machines may be used with programs in accordance with the teachings herein. Alternatively, the construction of more specialized apparatus to perform the required method steps may be appropriate. The structure of a conventional general purpose computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a general purpose computer. The computer readable medium may also include a hard-wired medium such as exemplified in the Internet system, or wireless medium such as exemplified in the GSM mobile telephone system. The computer program when loaded and executed on such a general-purpose computer effectively results in an apparatus that implements the steps of the preferred method.

The invention may also be implemented as hardware modules. More particular, in the hardware sense, a module is a functional hardware unit designed for use with other components or modules. For example, a module may be implemented using discrete electronic components, or it can form a portion of an entire electronic circuit such as an Application Specific Integrated Circuit (ASIC). Numerous other possibilities exist. Those skilled in the art will appreciate that the system can also be implemented as a combination of hardware and software modules.

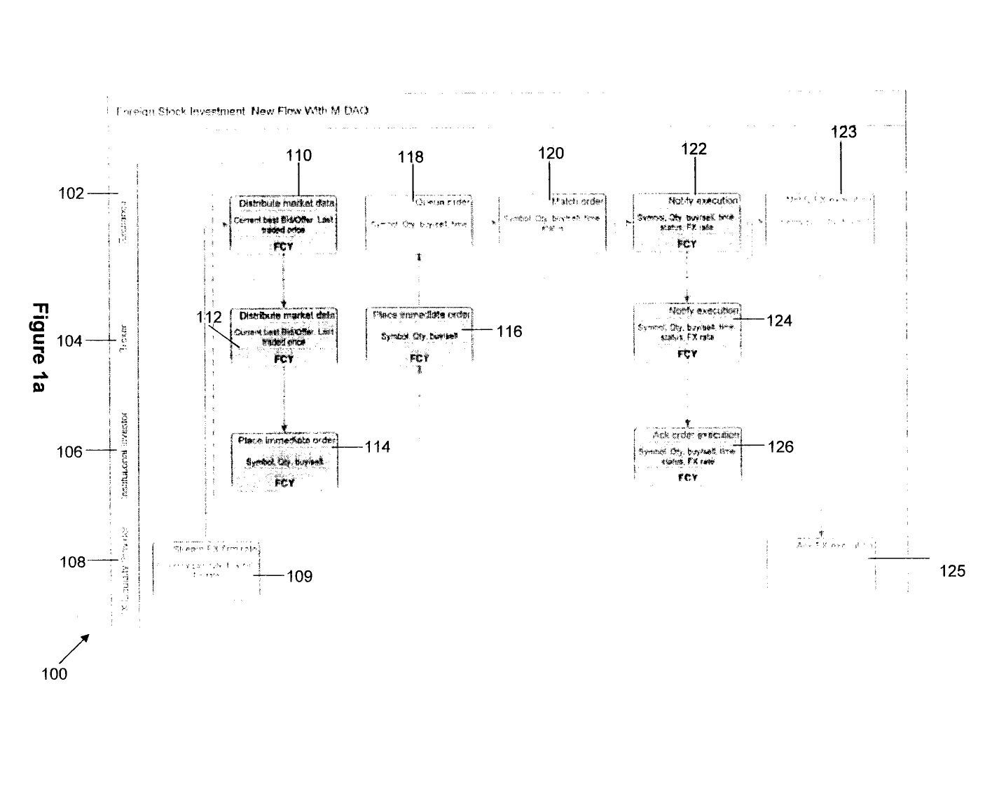

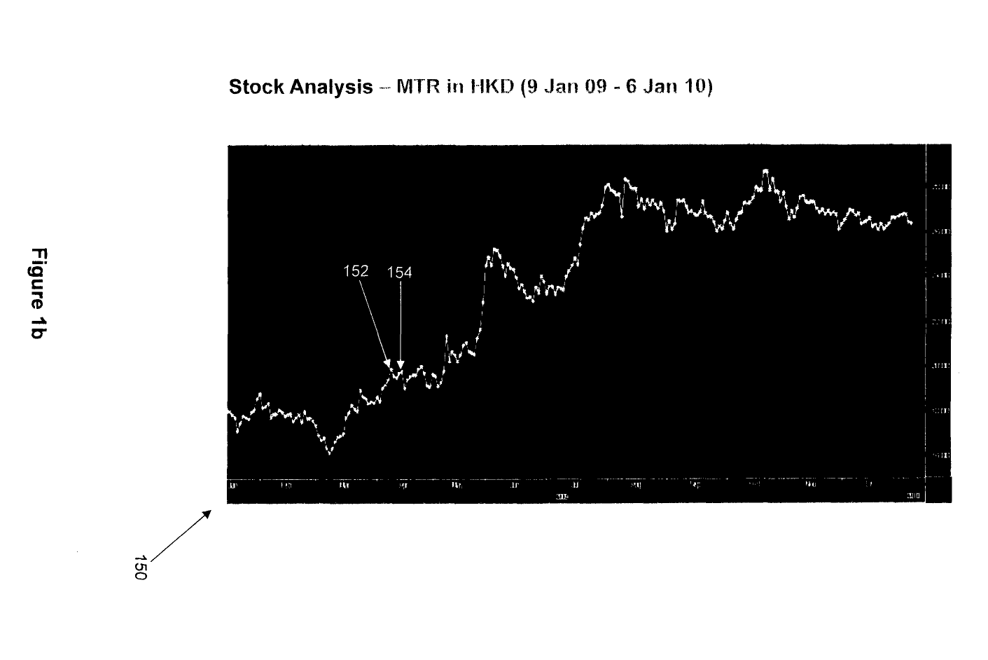

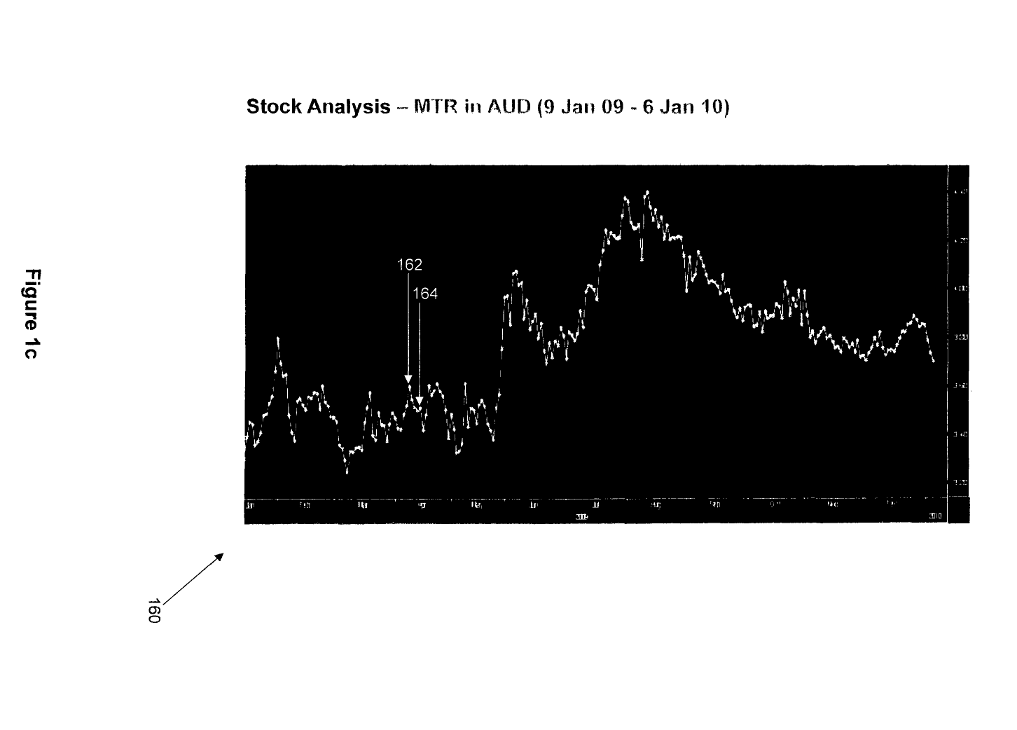

FIG. 1a is a flow chart, designated generally as reference numeral 100, illustrating the events that occur during a foreign stock investment trade in accordance with an embodiment of the invention. 4 main entities are involved in the foreign stock investment trade: an Exchange 102, a broker 104, an investor 106 and a FX Liquidity Provider 108 (e.g. a FX bank).

At step 109, the FX Liquidity Provider (LP) 108 streams real-time executable FX rates to the Exchange 102, for instance, via the industry standard Financial Information eXchange (FIX) protocol. Information such as the currency pair, whether to buy or sell, the quantity to be bought or sold, and the FX rate are streamed. Each FX LP can provide a particular bid/offer rate that is only valid for a pre-determined period of time (e.g.: 1s, 10s, etc). In this “time-to-live” (TTL) scheme, bid/offer rates have a pre-determined lifetime. Alternatively, in a “good-till-replaced” (GTR) scheme, a particular bid/offer rate is valid until it is replaced by another subsequent bid/offer rate. In both cases, a particular bid/offer rate is accompanied by a fixed amount of currency for which the bid/offer rate applies. For instance, a FX banks guarantees a USD-SGD bid/offer rate of 1.395/1.405 for USD 1 million. The plurality of bid/offer rates from each of the FX LPs are compiled and the best bid/offer rate is determined. In both schemes, when an updated bid/offer rate is provided, a new best bid/offer rate may be determined. Further details of the FX pricing in an example embodiment will be disclosed below.

At step 110, the Exchange 102 distributes market data such as current best Bid/Offer and Last Traded Price. The data provided is in a currency foreign to the Exchange 102 (e.g. the native currency of the foreign investor 106). The market data from step 110 is received by the broker 104 at step 112. The broker 104 in turn distributes the market data to the investor 106. At step 114, if the investor 106 decides to make a trade, he can place an immediate order in the foreign currency, and provide instructions regarding the symbol of the security, whether to buy or sell the security and the quantity to be bought or sold. At step 116, the broker 104 places the immediate order in the foreign currency on behalf of the investor 106 with the Exchange 102. The Exchange 102 queues the order at step 118. In addition to the information regarding the symbol of the security, whether to buy or sell the security and the quantity to be bought or sold; the time that the order is placed is noted by the Exchange 102. At step 120, the order is matched and the Exchange 102 notes information such as the symbol of the security, whether the security was bought or sold, the quantity that was bought or sold, the time that the order was matched and the status of the trade. At step 122, the Exchange notifies the broker 104 of the execution of the order, including the information mentioned above at step 120. Here, the information is provided in the foreign currency. In parallel with step 122, the Exchange 102 notifies the FX Liquidity Provider 108 of the FX execution. Information such as the currency pair, whether to buy or sell, and the quantity to be bought or sold, is provided. The best bid/offer rate, which is constructed from the plurality of bid/offer rates provided by the individual FX LPs, and will be described in more detail below, is “locked in” for a certain period of time and this rate is used in security trades for that certain period of time. At step 125, the FX Liquidity Provider 108 executes the FX transaction at the best bid/offer rate that was “locked-in” at step 110 and subsequently acknowledges the FX execution. At step 124, the broker 104 in turn notifies the investor 106 of the execution of the order. At step 126, the investor 106 acknowledges the execution of the order.

Embodiments of the present invention seek to exploit the fact that stock performance in a local currency differs from its performance in a foreign currency if the FX conversion rate is taken into consideration. FIG. 1b is a MTR stock performance chart in HK Dollars from 9 Jan. 2009 to 6 Jan. 2010, which is designated generally as reference numeral 150. FIG. 1c is the corresponding MTR stock performance chart converted into Australian Dollars based on the respective FX conversion rates, and is designated generally as reference numeral 160. For example, points 152 and 154 in FIG. 1b correspond to certain points in time, while points 162 and 164 in FIG. 1c correspond to the same points in time. Points 152 and 162 both correspond to a peak, but point 154 corresponds to a peak while point 164 corresponds to a trough (compared to point 162). An Australian investor who bought MTR stocks at a time corresponding to point 152/162, and sold at a time corresponding to point 154/164, would have lost more than a Hong Kong investor.

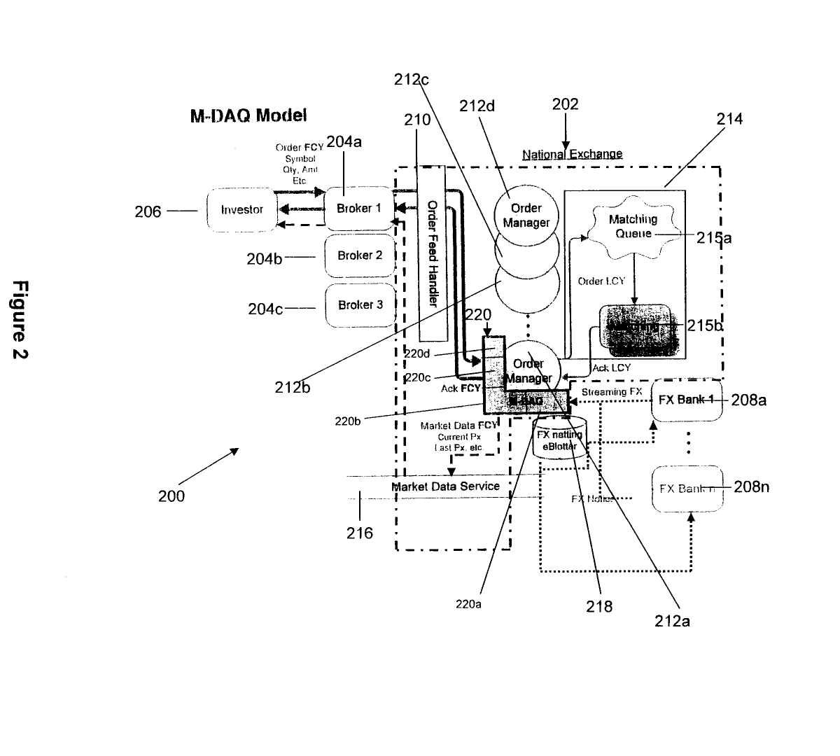

FIG. 2 is a schematic diagram, designated generally as reference numeral 200, illustrating the interactions that occur between entities and application modules during a foreign stock investment trade, according to an embodiment of the present invention. The entities involved in the foreign stock investment trade comprise a National Exchange 202, a plurality of brokers 204a/b/c, an investor 206 and a plurality of FX banks 208a/n. The application modules (that are associated with National Exchange 202) comprise an Order Feed Handler 210, a plurality of National Exchange Order Managers 212a/b/c/d, a matching module 214, a Market Data Service module 216 and a multi-denomination automated quotation platform 220. A FX netting eBlotter 218 is an application module that is associated with the plurality of FX banks 208a/n.

The FX netting eBlotter 218 (associated with the plurality of FX banks 208a/n) can (i) allow the plurality of FX banks 208a/n to configure the FX netting eBlotter 218 for FX trade aggregation and notification via a graphical user interface (GUI); (ii) allow the plurality of FX banks 208a/n to monitor trades, positions, profit/loss, etc; and (iii) construct a unique referencing code to facilitate quick cross referencing between the National Exchange 202, the plurality of FX banks' 208a/n FX rates and the plurality of brokers 204a/b/c. The logic of the eBlotter 218 can be implemented to comprise a plurality of databases representing “buckets”, wherein each “bucket” is associated with a different FCY (e.g.: USD, JPY, HKD) and configured to hold a certain amount of its currency for each liquidity provider. All FX transactions are filled into (or emptied from) the appropriate “bucket”. At the end of a trading session, any remaining position held by the liquidity providers can be flushed (i.e.: flush out the “cache”) and a ticket/notification is sent to the liquidity providers. Details of the flushing will be described below.

The multi-denomination automated quotation platform 220 comprises a FX pricing engine 220a, a Market Data Manager 220b, a FX Execution Manager 220c and an Order Manager 220d. The FX pricing engine 220a can receive streaming FX bid/offer rates from the plurality of FX banks 208a/n. The FX pricing engine 220a can then construct the best bid/offer rates in its memory and maintain a real time snapshot of the liquidity level of each of the plurality of FX banks 208a/n.

The Market Data Manager 220b can (i) subscribe to securities streaming prices published by the Exchange 202 in the local currency of the Exchange 202; (ii) convert securities prices to foreign currencies using FX rates given by the FX Pricing Engine 220a; and (iii) publish foreign currency denominated securities prices to the Exchange's market data service module 216. To achieve sub-millisecond price updates, the blending of the Exchange counter prices and FX rates runs through a price making algorithm. As mentioned above, each FX LP provides a bid/offer rate that is “locked in” for a certain period of time. For example, a FX LP provides a USD-SGD bid/offer rate of 1.395/1.410. A second FX LP provides a USD-SGD bid/offer rate of 1.405/1.415. A third FX LP provides a USD-SGD bid/offer rate of 1.390/1.420. A price making algorithm obtains the various bid/offer rates from the plurality of FX LPs and selects the best bid/offer rate. In the example above, the price making algorithm selects the best bid/offer rate which is 1.405/1.410. Whenever an updated bid/offer rate is provided, a new best bid/offer rate is determined.

The FX Execution Manager 220c implements the FX Application Programming Interfaces (APIs) of the plurality of FX banks 208a/n and can

(i) receive securities Order Acknowledgements from the Order Manager 220d.

(ii) update the plurality of FX banks' 208a/n FX netting eBlotter 218 and aggregation information. Through the aggregation model described above, embodiments of the present invention reduce the number of FX orders between counterparties as smaller individual transactions are aggregated, which helps to reduce cost of settlement. This is because every transaction involves a settlement cost.

The Order Manager 220d of the platform 220 can (i) accept foreign currency denominated securities orders from the plurality of brokers 204a/b/c; (ii) convert the foreign currency denominated securities orders into the local currency (of the Exchange 202); (iii) route the orders to the Exchange's 202 matching queue 215a; (iv) receive Order Acknowledgements (i.e. Execution notices) in local currency from the Exchange's 202 matching module 214; (v) send Order Acknowledgements (with original FX information) or Rejections to the plurality of brokers 204a/b/c; and (vi) detail the order handling process.

The flow of trading data between the investor 206, the plurality of brokers 204a/b/c, the Order Feed Handler 210, the plurality of National Exchange Order Managers 212a/b/c/d, the matching module 214 and the platform 220 is illustrated by solid arrows and comprise:
a) The investor 206 placing an order with one of the plurality of brokers 204a/b/c (illustrated in FIG. 2 as Broker 1 204a), and provides instructions such as the symbol of the security, whether to buy or sell the security and the quantity to be bought or sold. The relevant instructions are in a currency foreign to the Exchange 202 (e.g. the native currency of the foreign investor 206).
b) The broker 204a placing the order on behalf of the investor 206 with the National Exchange 202 via the Order Feed Handler 210. The order being transmitted from the Order Feed Handler 210 to the Order Manager 220d of the platform 220.
c) The Order Manager 220d of the platform 220 processing the order and transmitting the order to one of the plurality of National Exchange Order Managers 212a/b/c (illustrated in FIG. 2 as Order Manager 212a).
d) The matching module 214 receiving the order from Order Manager 212a and queues 215a the order. If a match 215b is made, the trade is executed.
e) The matching module 214 transmitting the execution status of the trade to back the Order Manager 212a.
f) The Order Manager 220d of the platform 220 receiving the execution status of the trade from Order Manager 212a.
g) The broker 204a receiving the execution status of the trade from the Order Manager 220d via the Order Feed Handler 210.
h) The broker 204a notifying the investor 206 of the execution of the order.

The flow of market data between the investor 206, the plurality of brokers 204a/b/c, the Market Data Service module 216 and the Market Data Manager 220b of the platform 220 is illustrated by dashed arrows and comprise:
a) Market Data Manager 220b subscribing to market data such as current best Bid/Offer and Last Traded Price of securities from the Market Data Service module. The Market Data Manager 220b can convert securities prices (in local currencies) to foreign currencies using FX rates provided by the FX Pricing Engine 220a. The Market Data Manager 220b publishes these converted securities prices thereby advantageously enabling the market data to be in a currency foreign to the Exchange 202 (e.g. the native currency of the foreign investor 206).
b) The plurality of brokers 204a/b/c individually accessing the Market Data Service module 216 to obtain the market data.
c) The plurality of brokers 204a/b/c distributing the market data to the investor 206.

The interactions between the platform 220, the FX netting eBlotter 218 and the plurality of FX banks 208a/n are illustrated by dotted arrows and comprise:
a) The plurality of FX banks 208a/n streaming FX bid/offer rates to the FX pricing engine 220a of the platform 220.
b) The FX Execution Manager 220c sending FX orders to the plurality of FX banks 208a/n and updating the FX netting eBlotter 218 and aggregation information.
c) The FX netting eBlotter 218 can allowing the plurality of FX banks 208a/n to monitor trades, positions, profit/loss, etc

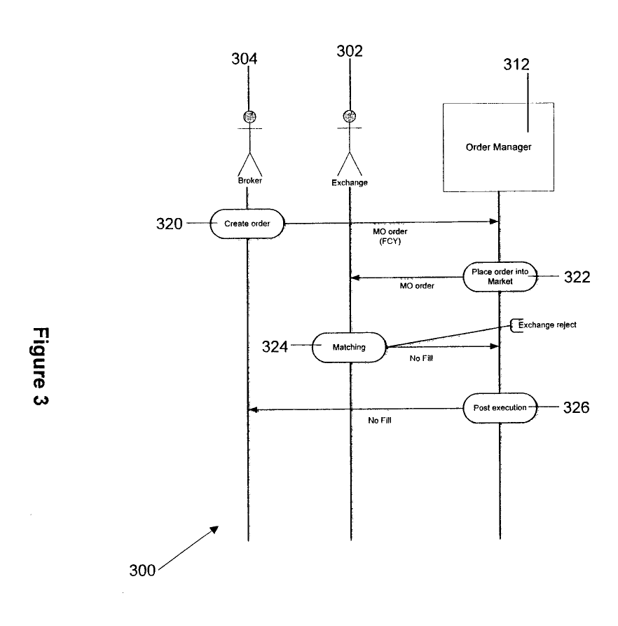

FIG. 3 is a schematic diagram, designated generally as reference numeral 300, illustrating the processes performed by an Order Manager 312 during a “No Fill” condition when a Market Order (MO) is placed, according to an embodiment of the present invention. During a “Create Order” process 320, a broker 304 creates a MO in the foreign currency (FCY) of an Exchange 302 and the MO is passed to the Order Manager 312. During a “Place Order into Market” process 322, the Order Manager 312 places the order on the Exchange 302. During a “Matching” process 324, the Exchange 302 attempts to match the order. If no match can be made, the Exchange rejects the order and a “No Fill” condition arises. The Order Manager 312 is notified of the “No Fill” condition. During a “Post Execution” process 326, the broker 304 is notified of the “No Fill” condition by the Order Manager 312.

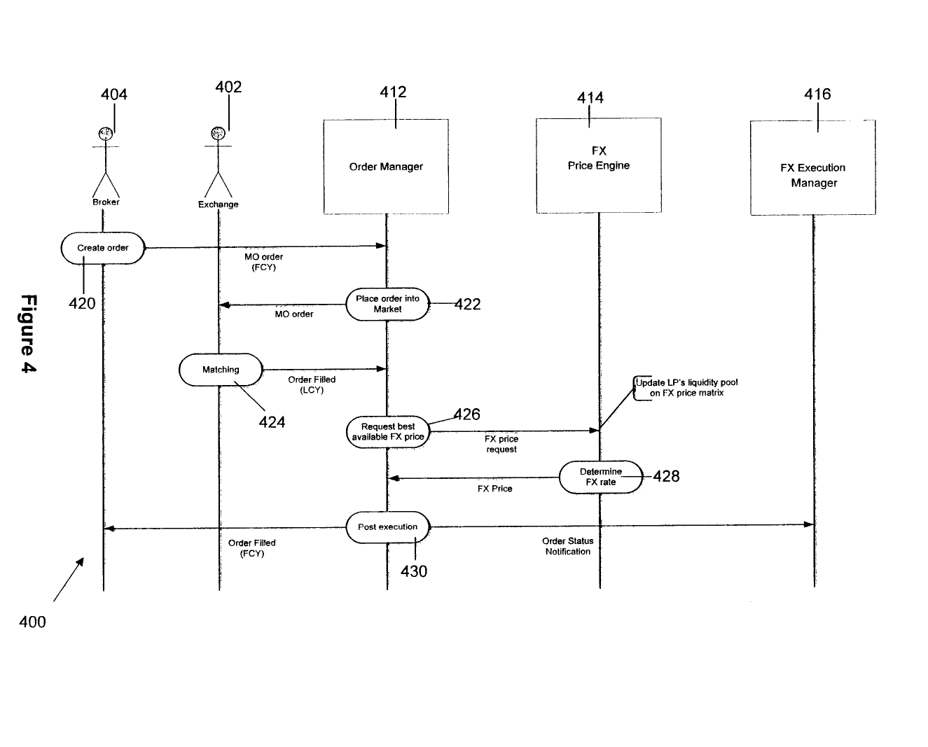

FIG. 4 is a schematic diagram, designated generally as reference numeral 400, illustrating the processes performed by an Order Manager 412 during a “Filled” condition when a Market Order (MO) is placed, according to an embodiment of the present invention. During a “Create Order” process 420, a broker 404 creates a MO in the foreign currency (FCY) of an Exchange 402 and the MO is passed to the Order Manager 412. During a “Place Order into Market” process 422, the Order Manager 412 places the order on the Exchange 402. During a “Matching” process 424, the Exchange 402 attempts to match the order. If a match can be made, the order is “Filled” in the local currency (LCY) of the Exchange 402. During a “Request Best Available FX Price” process 426, the Order Manager 412 requests the best FX price from a FX Pricing Engine 414. The FX Pricing Engine 414 can receive streaming FX bid/offer rates from a plurality of FX banks and can also construct the best bid/offer rates in its memory and maintain a real time snapshot of the liquidity level of each of the plurality of FX banks. During a “Determine FX Rate” process 428, the FX Pricing Engine 414 provides the Order Manager 412 with the best available FX rate. During a “Post Execution” process 430, the Order Manager 412 notifies the broker 404 of the “Filled” condition, with information provided in the foreign currency (FCY) of the Exchange 402. The Order Manager 412 also notifies a FX Execution Manager 416 of the Order Status (i.e.: a FX transaction is to be executed using the best available FX rate that was obtained).

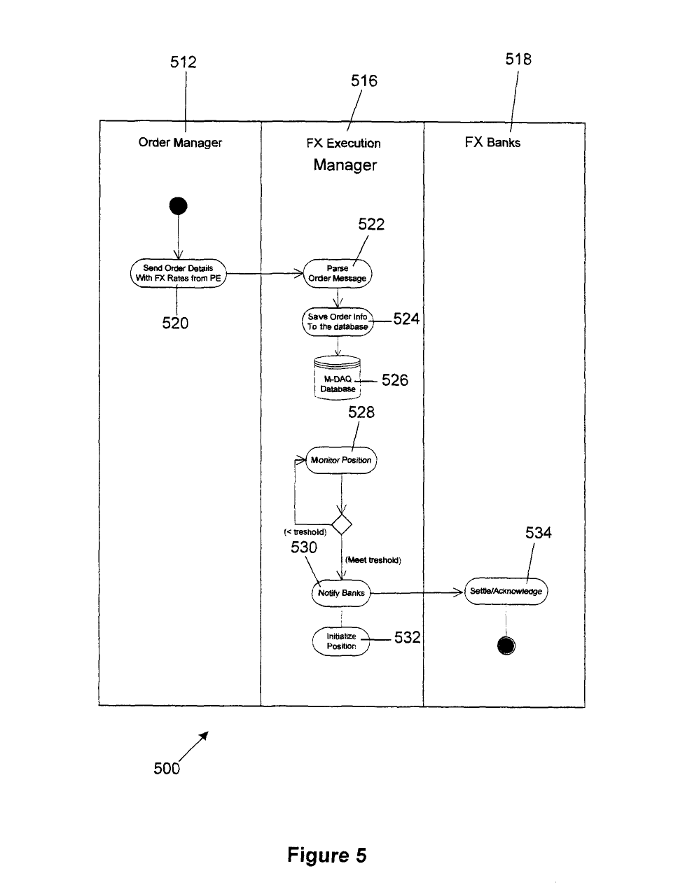

FIG. 5 is a schematic diagram, designated generally as reference numeral 500, illustrating the processes performed by an FX Execution Manager 516, according to an embodiment of the present invention. During process 520, an order Manager 512 can send Order details (with FX rates from a FX pricing engine) to the FX Execution Manager 516. During process 522, the FX Execution Manager 516 parses the Order message. During process 524, FX Execution Manager 516 saves the Order information into a database 526. The FX Execution Manager 516 can also monitor a trading position at process 528. If the trading position is less than the threshold, the FX Execution Manager 516 continues to constantly monitor the position. If the threshold is met, a FX bank 518 can be notified at process 530. At process 532, the trading position is initialized wherein the “buckets” in the eBlotter are reset to their original level (e.g.: a certain base level of currency). At process 534, the FX bank 518 settles and acknowledges the transaction.

In an alternative embodiment of the present invention, a Limit Order Virtual Queue may be implemented when the investor wishes to place a limit order rather than a market order. In such an implementation, only the same local Currency Central Limit Order Book (e.g. JPY in Tokyo SE or SGD in SGX) is maintained and there can be multiple virtual queues for the foreign currency order books to constantly mark-to-market/re-price the local currency equivalents (of a foreign currency limit order). Furthermore, time priority (vis-à-vis the entire Order Book—Physical and Virtual) can be retained.

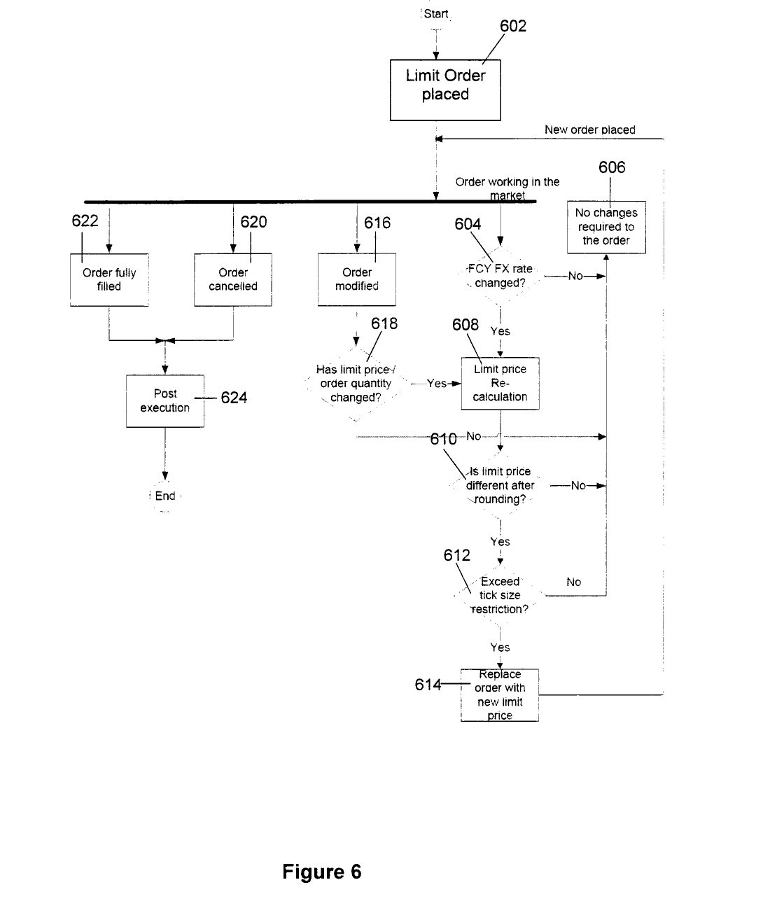

FIG. 6 is a flow chart, designated generally as reference numeral 600, illustrating the events that occur during a Limit Order foreign stock investment trade in accordance with an embodiment of the invention. At step 602, a foreign currency (FCY) limit order is placed. For instance, an investor can place a “No Worse Than-FCY Terms” Limit Order with a Broker via a FCY Stock Symbol e.g. ABC.USD. A local currency (LCY) Limit Order can be derived from the FCY Limit Order and sent to a core LCY Order Book at the Exchange. The core LCY Order Book maintains price and time priorities.

At step 604, the relevant FCY FX rate is monitored for any changes. At step 606, if the FX rate remains unchanged, no changes are made to the limit order. At step 608, if there are changes to the FX rates, a new LCY limit price can be computed based on the changes. All the limit orders can be examined and a normal curve (with a minimum sample size of about 30) is constructed and the Confidence Interval (CI) of, for example, +/−3 sigma can be found so as to derive a statistical confidence of 99.97%. This may advantageously reduce the number of limit orders that require re-calculation at any given point in time, thus reducing machine processor load and latency.

At step 610, the new LCY limit price (after rounding) is checked. If there are no changes to the LCY limit price after rounding, no changes are made to the limit order (see step 606). The tick size restriction is checked to determine if is exceeded at step 612. If the tick size restriction is not exceeded, no changes are made to the limit order (see step 606). At step 614, if the tick size restriction is exceeded, the limit order is re-priced and replaced with the new limit price. The re-priced LCY limit price is compared to all similar price levels (in FCY) that were originally placed and the exact priority order is retained to send these better (chances of being matched) prices to the core LCY Order Book. The previous limit order is cancelled and replaced. In other words, a new LCY time priority order is given.

For example, when the investor sets a total settlement price in a foreign currency (e.g. to buy MTR stocks in HKD with USD2.55, and this translates into a derived initial order of HKD19.7625 @7.75). The market for MTR is now trading at HKD19.90. Should the USD-HKD rate move to 7.8039, his derived virtual price would be HKD19.8999 and can now join the main book (with the previous HKD19.7625 price cancelled). This advantageously ensures that the buyer does not pay more than USD2.55.

After a limit order is placed (see step 602) and the limit order is subsequently modified (see step 616), the order quantity or limit price is monitored for changes at step 618. If there is no change to the order quantity or limit price, no changes are made to the limit order at step 606. If there is a change to the order quantity or limit price, a new LCY limit price can be computed (see step 608). Steps 610, 612 and 614 as described above may follow.

After a limit order is placed (see step 602) and the limit order is subsequently cancelled (see step 620) or the order is fully filled (see step 622), the post execution stage may be entered at step 624.

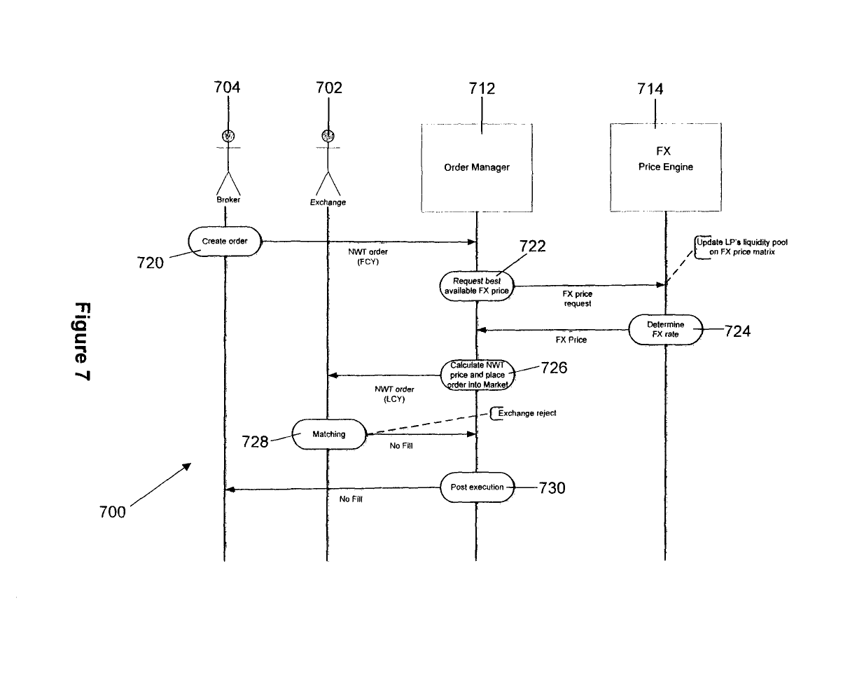

FIG. 7 is a schematic diagram, designated generally as reference numeral 700, illustrating the processes performed by an Order Manager 712 during a “No Fill” condition when a Limit Order (e.g. “No Worse Than” (NWT) Order) is placed, according to an embodiment of the present invention. During a “Create Order” process 720, a broker 704 creates a NWT Order in the foreign currency (FCY) of an Exchange 702 and the NWT Order is passed to the Order Manager 712. During a “Request Best Available FX Price” process 722, the Order Manager 712 requests the best FX price from a FX Pricing Engine 714. The FX Pricing Engine 714 can receive streaming FX bid/offer rates from a plurality of FX banks and can also construct the best bid/offer rates in its memory and maintain a real time snapshot of the liquidity level of each of the plurality of FX banks. During a “Determine FX Rate” process 724, the FX Pricing Engine 714 provides the Order Manager 712 with the best available FX rate. During a “Calculate NWT Price and Place Order into Market” process 726, the Order Manager 712 calculates the NWT price and places the order into the market on the Exchange 702 in the local currency (LCY) of the Exchange 702. During a “Matching” process 728, the Exchange 702 attempts to match the order. If no match can be made, the Exchange rejects the order and a “No Fill” condition arises. The Order Manager 712 is notified of the “No Fill” condition. During a “Post Execution” process 730, the broker 704 is notified of the “No Fill” condition by the Order Manager 712.

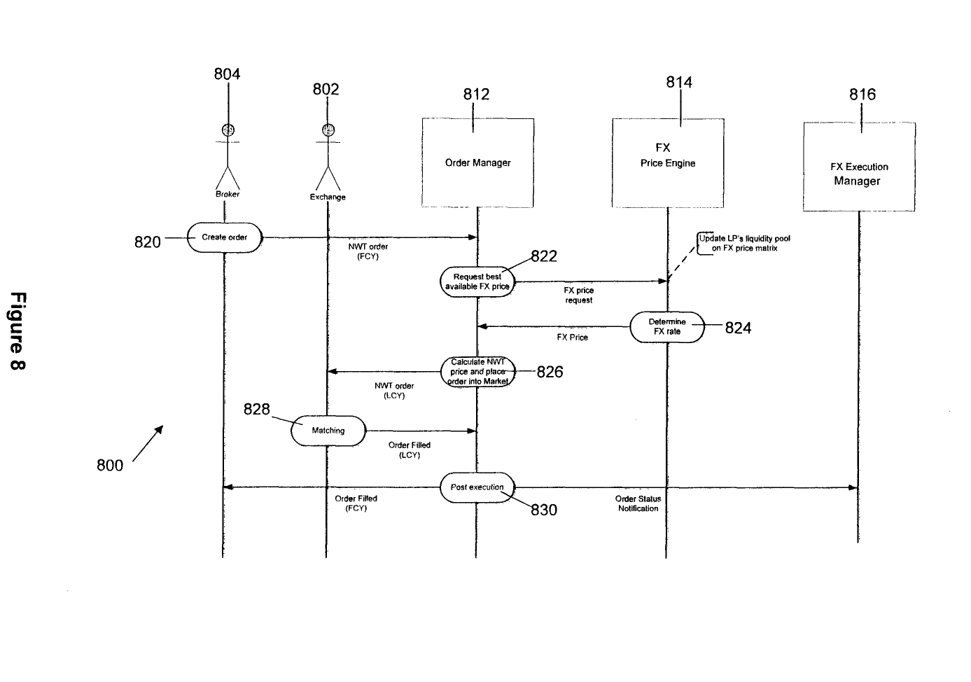

FIG. 8 is a schematic diagram, designated generally as reference numeral 800, illustrating the processes performed by an Order Manager 812 during a “Filled” condition when a Limit Order (e.g. “No Worse Than” (NWT) Order) is placed, according to an embodiment of the present invention. During a “Create Order” process 820, a broker 804 creates a NWT Order in the foreign currency (FCY) of an Exchange 802 and the NWT Order is passed to the Order Manager 812. During a “Request Best Available FX Price” process 822, the Order Manager 812 requests the best FX price from a FX Pricing Engine 814. The FX Pricing Engine 814 can receive streaming FX bid/offer rates from a plurality of FX banks and can also construct the best bid/offer rates in its memory and maintain a real time snapshot of the liquidity level of each of the plurality of FX banks. During a “Determine FX Rate” process 824, the FX Pricing Engine 814 provides the Order Manager 812 with the best available FX rate. During a “Calculate NWT Price and Place Order into Market” process 826, the Order Manager 812 calculates the NWT price and places the order into the market on the Exchange 802 in the local currency (LCY) of the Exchange 802. During a “Matching” process 828, the Exchange 802 attempts to match the order. If a match can be made, the order is “Filled” in the local currency (LCY) of the Exchange 802. During a “Post Execution” process 830, the Order Manager 812 notifies the broker 804 of the “Filled” condition, with information provided in the foreign currency (FCY) of the Exchange 802. The Order Manager 812 also notifies a FX Execution Manager 816 of the Order Status (i.e.: a FX transaction is to be executed using the best available FX rate that was obtained).

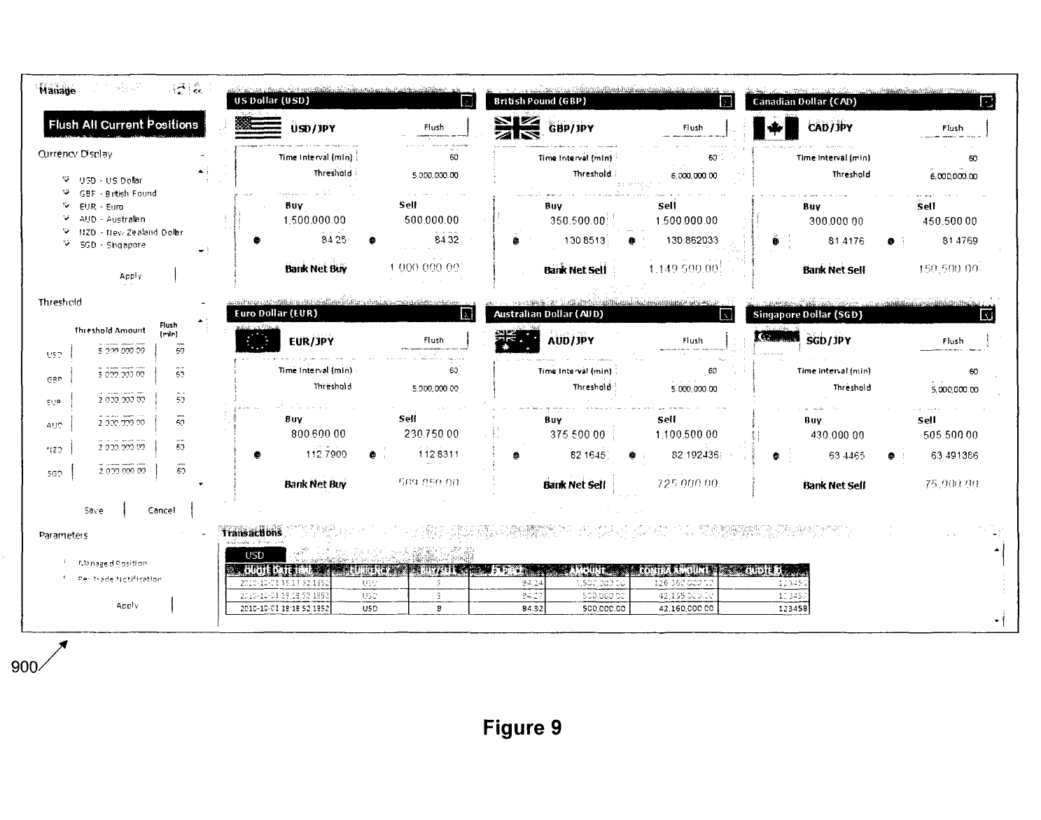

In an example embodiment of the present invention, when a FX Liquidity Provider provides firm streaming rates to users, a Rule-Based Automated Threshold System (RATS) is advantageously employed in the eBlotter 218 (described above) to offer monitoring solutions for Liquidity Providers for checking their FX exposure. With the RATS system, various logics can be implemented for the tracking of transactions and to allow transparency. Furthermore, at the end of a trading session, the RATS system can flush out any remaining position held by the liquidity providers (i.e.: flush out the “cache”) and a ticket/notification is sent to them. A Graphical User Interface (GUI) can also be provided to the Liquidity Providers for their easy monitoring and setting of threshold levels. FIG. 9 is a screen capture, designated generally as reference numeral 900, of a graphical user interface (GUI) provided to the one or more FX banks 108.

In example embodiments of the present invention, the various RATS logics that can be implemented include: (1) Aggregated Threshold, (2) Time Based Trigger, (3) Manual Flushing, and (4) No Rules Applied.

An Aggregated Threshold logic allows the flexibility for Liquidity Providers to set a stipulated Threshold for any currency pair. The Liquidity Providers can adjust their amount of exposure to FX risk at any point of time through the GUI made available to them. Once the Aggregated Threshold is triggered (i.e.: the threshold is breached), (i) aggregation or (ii) netting can be done on the trades and a ticket is sent to the Liquidity Providers. This logic may be used in conjunction with the Time-Based Trigger or Manual Flushing logic.

Advantages of this logic include the minimization of operation handling costs (e.g.: FX ticketing cost; and reduction in bandwidth/system capacity/throughput), timely risk notification and netting advantage. However, there is the risk of small positions not being covered.

The RATS system also advantageously provides the Liquidity Provider with the option as to how they would like to receive the ticket/notification:
Aggregated basis (Total long position and Total short position) which sends one ticket for the Long position and one ticket for the Short position for a currency pair.
Netted basis (Net position between Long and Short Position) which sends a single ticket/notification for a currency pair.

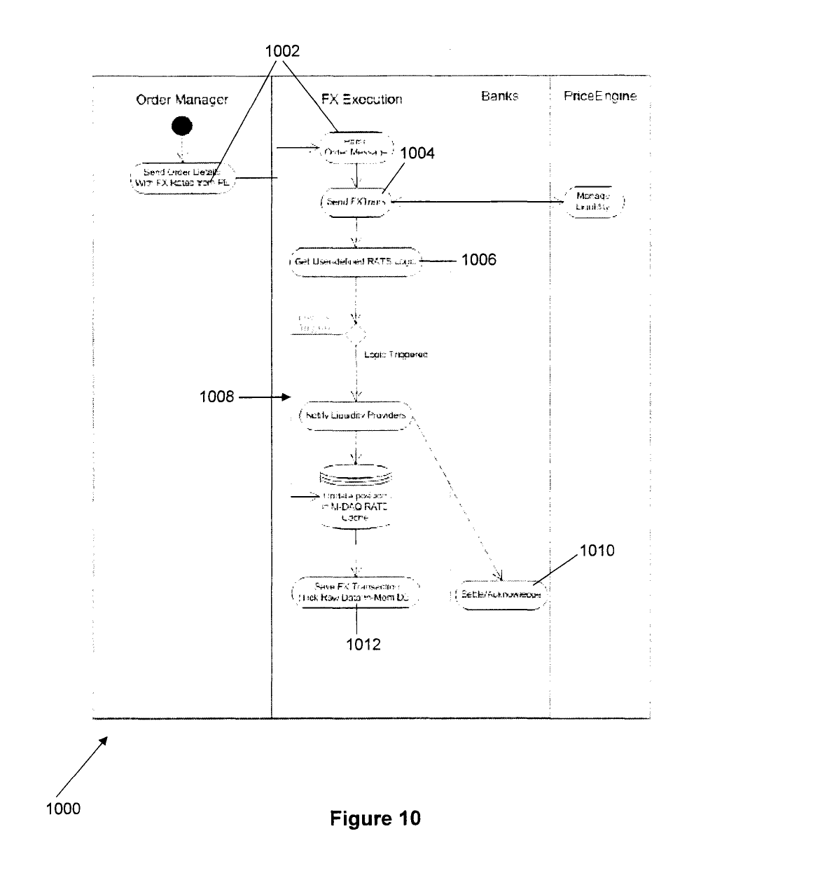

FIG. 10 is a flowchart, designated generally as reference numeral 1000, illustrating the workflow in a foreign stock investment trade using the RATS system, according to an embodiment of the present invention. At step 1002, a “BUY” or “SELL” order is filled and the details of the transaction are stored in the RATS cache (“bucket”). At step 1004, the corresponding FX transaction is sent to a pricing engine from the RATS system to manage liquidity. At step 1006, the Liquidity Provider's defined RATS logic is obtained and stored in the RATS system. At step 1008, the Liquidity Provider's stipulated threshold and logic is checked and once the threshold is breached, the cache is flushed and a ticket/notification is sent to the Liquidity Provider to inform them on the position for settlement (step 1010). At step 1012, the FX transaction is saved. If the threshold is not breached, the system continues to monitor the Liquidity Provider's FX position in relation to the threshold.

There are 3 options in which the Liquidity Providers can choose to flush the cache:

A. Flush all amount when the threshold is triggered;

B. Flush out at ±5% range of the stipulated threshold; or

C. Flush out enough to get just below the stipulated threshold.

Considerations associated with the various options for flushing the cache are:

| | Option | | |
|---|---|---|---|
| Considerations | A | B | C |
| Optimising Netting Benefit | | ✓ | ✓✓ |
| Minimise Bandwidth | ✓✓ | ✓ | |
| Consumption | | | |

To illustrate complete flushing when a threshold is triggered, for example, a US based investor decides to invest in a Japanese Stock listed in Tokyo Stock Exchange by buying 10,000 shares @ USD 33/share. The investor inputs the “Buy” order in his own preferred currency (USD). This order is converted to the currency in which the securities are traded in (JPY). The equity order in terms of the local currency is sent to Exchange and the FX transaction is undertaken by the Liquidity Providers.

In this example, assume that for the USD/JPY currency pair, only one Liquidity Provider, A, offers a bid of 80.52. Accordingly, the USD is converted to JPY based on the best rate available, which in this case is 80.52. i.e.: (USD 33*10,000 Securities)*80.52=Yen 26,571,600

This order, in JPY, is filled and the following details are entered in the RATS cache:

| Order | | | CCY | Buy/ | Trade | | FX | Value | Foreign |
|---|---|---|---|---|---|---|---|---|---|
| No. | Trade Date | Time | Pair | Sell | Amount | CCY | Rate | Date | Amt. |
| 1 | 2010 Nov. 02 | 09:12:34.123 | USDJPY | BUY | 26571600 | JPY | 80.52 | SPOT | 330000 |

If the Liquidity Provider sets a threshold of USD 1,000,000, the above entry does not breach the threshold.

Subsequently, multiple trades are transacted and their details entered in the RATS cache:

| Order | | | CCY | Buy/ | Trade | | FX | Value | Foreign |
|---|---|---|---|---|---|---|---|---|---|
| No. | Trade Date | Time | Pair | Sell | Amount | CCY | Rate | Date | Amt. |
| 1 | 2010 Nov. 02 | 09:12:34.123 | USDJPY | BUY | 26571600 | JPY | 80.52 | SPOT | 330000 |
| 2 | 2010 Nov. 02 | 09:12:35.1289 | USDJPY | SELL | 8054000 | JPY | 80.54 | SPOT | 100000 |
| 3 | 2010 Nov. 02 | 09:12:40.547 | USDJPY | BUY | 24153000 | JPY | 80.51 | SPOT | 300000 |
| 4 | 2010 Nov. 02 | 09:13:00.753 | USDJPY | SELL | 8053000 | JPY | 80.53 | SPOT | 100000 |
| 5 | 2010 Nov. 02 | 09:13:01.12709 | USDJPY | BUY | 20132500 | JPY | 80.53 | SPOT | 250000 |
| 6 | 2010 Nov. 02 | 09:13:02.82101 | USDJPY | BUY | 40260000 | JPY | 80.52 | SPOT | 500000 |

The RATS cache can be flushed on an aggregated basis or netted basis, details of which are as follows:

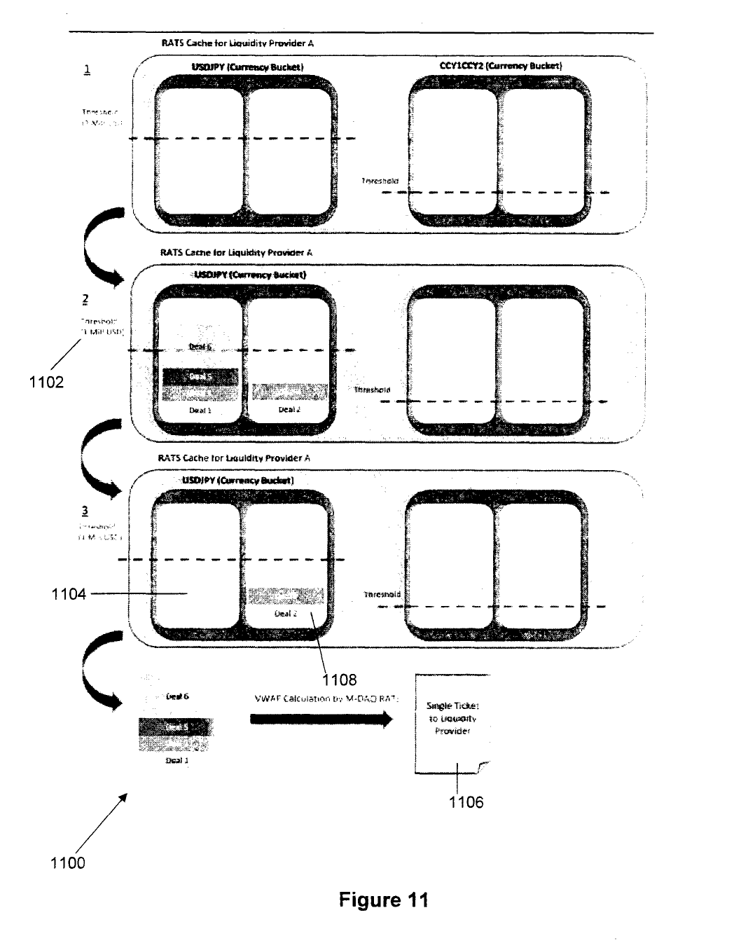

FIG. 11 is a schematic, designated generally as reference numeral 1100, illustrating the filling and complete flushing of the cache on an aggregated basis, according to an embodiment of the present invention.

On an aggregated basis, the Liquidity Provider has a Long Position of USD 1,380,000 which breaches the threshold 1102. The cache is flushed 1104 and cleared of “Buy” orders (deals 1, 3, 5 and 6) and a single ticket/notification 1106 is sent to the Liquidity Provider:

| Trade Date | CCY Pair | Buy/Sell | Trade Amt | Trade CCY | FX Rate | Value Date |
|---|---|---|---|---|---|---|
| 2010 Nov. 02 | USDJPY | BUY | 111117100 | JPY | 80.51964 | SPOT |

The ticket is based on the Volume-Weighted Average Price (VWAP) of the total transactions involved, wherein “Total Trade Amount/Total Foreign Amount=VWAP FX Rate”

After the cache is flushed, only “sell” orders (deals 2 and 4) 1108 remain in the RATS cache for Liquidity Provider A:

| Order | | | CCY | Buy/ | Trade | | FX | Value | Foreign |
|---|---|---|---|---|---|---|---|---|---|
| No. | Trade Date | Time | Pair | Sell | Amount | CCY | Rate | Date | Amt. |
| 2 | 2010 Nov. 02 | 09:12:35.1289 | USDJPY | SELL | 8054000 | JPY | 80.54 | SPOT | 100000 |
| 4 | 2010 Nov. 02 | 09:13:00.753 | USDJPY | SELL | 8053000 | JPY | 80.53 | SPOT | 100000 |

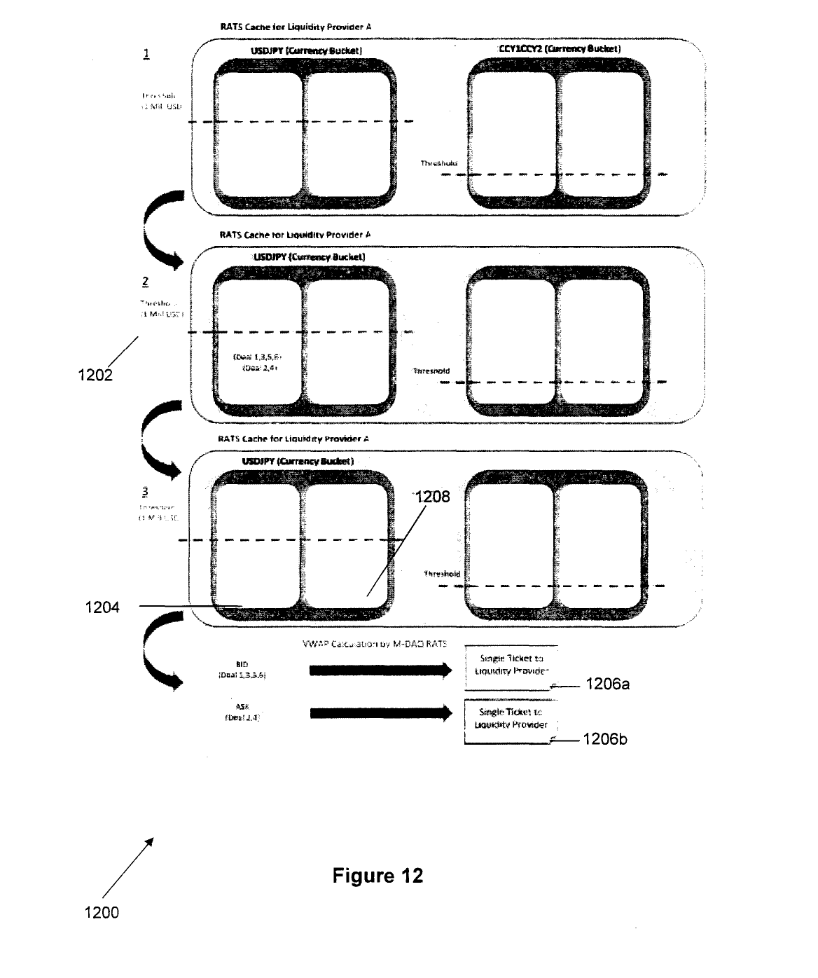

FIG. 12 is a schematic, designated generally as reference numeral 1200, illustrating the filling and complete flushing of the cache on a netted basis, according to an embodiment of the present invention.

On a Netted basis, the Liquidity Provider has a Long Position of USD 1,180,000 which breaches the threshold 1202. The entire cache is flushed 1204 and 2 tickets/notifications 1206a/b are sent to the Liquidity Provider:

| Trade Date | CCY Pair | Buy/Sell | Trade Amt | Trade CCY | FX Rate | Value Date |
|---|---|---|---|---|---|---|
| 2010 Nov. 02 | USDJPY | BUY | 111117100 | JPY | 80.51964 | SPOT |
| 2010 Nov. 02 | USDJPY | SELL | 16107000 | JPY | 80.5350 | SPOT |

Similarly, the tickets are based on the Volume-Weighted Average Price (VWAP) of the total transactions involved, wherein “Total Trade Amount/Total Foreign Amount=VWAP FX Rate”

After the entire cache is flushed, no orders 1208 remain in the RATS cache for Liquidity Provider A:

| Order | Trade | | CCY | Buy/ | Trade | | FX | Foreign |
|---|---|---|---|---|---|---|---|---|
| No. | Date | Time | Pair | Sell | Amount | CCY | Rate | Amt. |
| — | — | — | — | — | — | — | — | — |

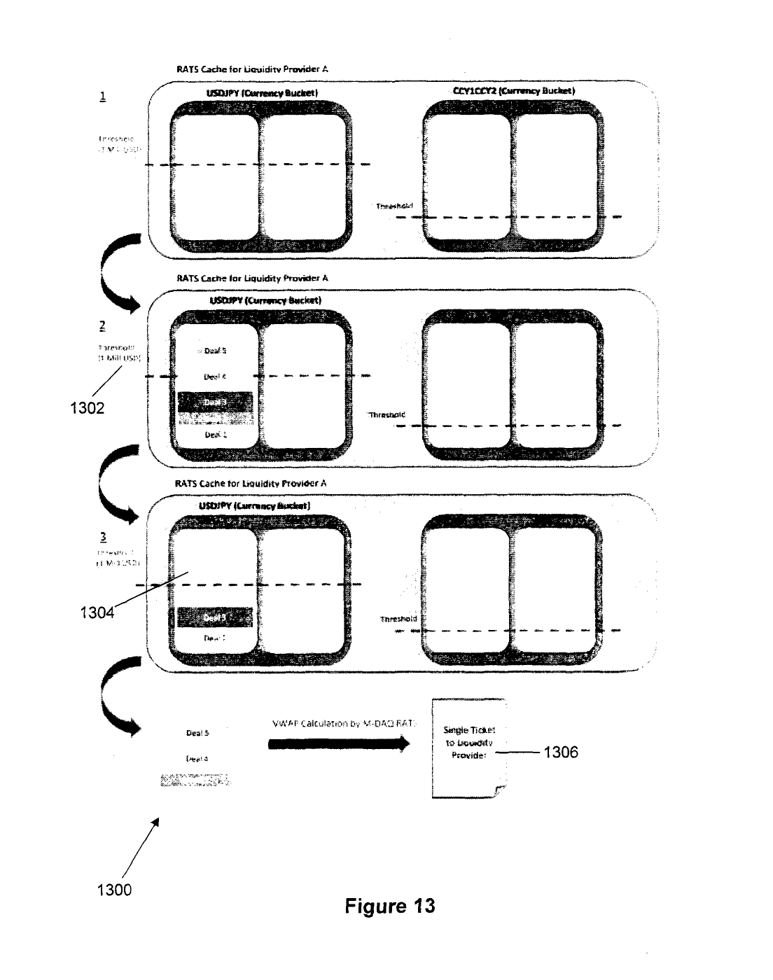

FIG. 13 is a schematic, designated generally as reference numeral 1300, illustrating the filling and flushing of the cache at ±5% range of the stipulated threshold, according to an embodiment of the present invention.

With this logic, the Liquidity Provider can choose to flush the currency transactions amount at ±5% range of the stipulated threshold.

For example, assume a RATS cache for Liquidity Provider A is as follows:

| Order | | | CCY | Buy/ | Trade | | FX | Value | Foreign |
|---|---|---|---|---|---|---|---|---|---|
| No. | Trade Date | Time | Pair | Sell | Amount | CCY | Rate | Date | Amt. |
| 1 | 2010 Nov. 02 | 09:30:01.253 | USDJPY | BUY | 26571600 | JPY | 80.52 | SPOT | 330000 |
| 2 | 2010 Nov. 02 | 09:30:01.654 | USDJPY | BUY | 7248600 | JPY | 80.54 | SPOT | 90000 |
| 3 | 2010 Nov. 02 | 09:30:02.2555 | USDJPY | BUY | 24153000 | JPY | 80.51 | SPOT | 300000 |
| 4 | 2010 Nov. 02 | 09:30:02.45 | USDJPY | BUY | 40260000 | JPY | 80.52 | SPOT | 500000 |
| 5 | 2010 Nov. 02 | 09:30:02.451 | USDJPY | BUY | 32252265 | JPY | 80.53 | SPOT | 400500 |

Once the threshold is breached 1302, the transactions are sorted in descending order based on the foreign amount as follows:

| Order | | | CCY | Buy/ | Trade | | FX | Value | Foreign |
|---|---|---|---|---|---|---|---|---|---|
| No. | Trade Date | Time | Pair | Sell | Amount | CCY | Rate | Date | Amt. |
| 4 | 2 Nov. 2010 | 09:30:02.45 | USDJPY | BUY | 40260000 | JPY | 80.52 | SPOT | 500000 |
| 5 | 2 Nov. 2010 | 09:30.02.451 | USDJPY | BUY | 32252265 | JPY | 80.53 | SPOT | 400500 |
| 1 | 2 Nov. 2010 | 09:30:01.253 | USDJPY | BUY | 26571600 | JPY | 80.52 | SPOT | 330000 |
| 3 | 2 Nov. 2010 | 09:30:02.2555 | USDJPY | BUY | 24153000 | JPY | 80.51 | SPOT | 300000 |
| 2 | 2 Nov. 2010 | 09:30:01.654 | USDJPY | BUY | 7248600 | JPY | 80.54 | SPOT | 90000 |

Thereafter, the RATS system computes the various trade combinations and sends a VWAP notification/ticket to the liquidity provider regarding the trades involved.

In this example, there are 2 combinations that are in the ±5% range of the threshold of USD 1,000,000.

Combination 1=Order No 4+Order No 5+Order No 2:

500000+400500+90000=990500

Combination 2=Order No 5+Order No 1+Order No 3:

400500+330000+300000=1030500

The combination nearest to the threshold is derived by applying the following formula, with the closest match being 0%:

$$( 1 )$$

$$\frac{\vert ( Summed Result of Each Combination ) - Threshold \vert}{Threshold} \times 100 \% \qquad$$

Accordingly, Combination 1: 0.95% and Combination 2: 3.05%. With Combination 1 being nearest the threshold, the RATS system sends a VWAP ticket/notification to the Liquidity Provider based on the orders of Combination 1. These orders are flushed out 1204 from the RATS cache as follows:

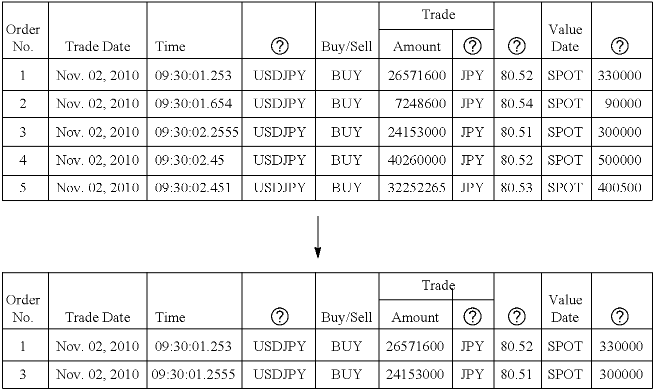

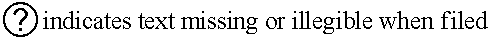

A ticket/notification 1306 is sent to the Liquidity Provider:

| Trade Date | CCY Pair | Buy/Sell | Trade Amt | Trade CCY | FX Rate | Value Date |
|---|---|---|---|---|---|---|
| 2010 Nov. 02 | USDJPY | BUY | 79760865 | JPY | 80.5259 | SPOT |

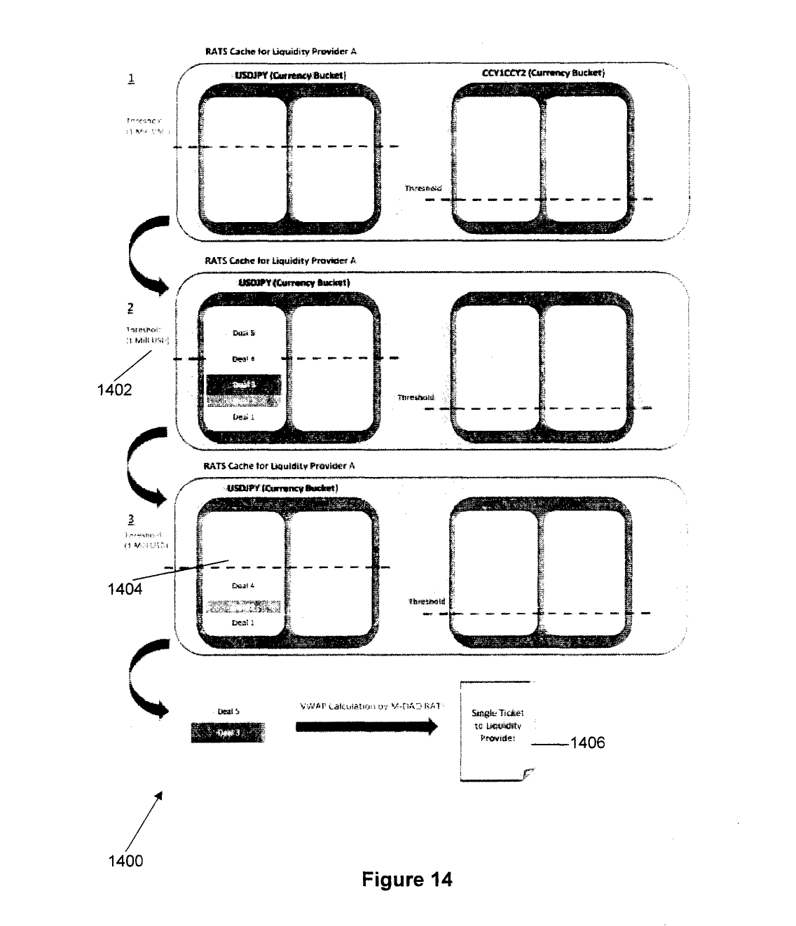

FIG. 14 is a schematic, designated generally as reference numeral 1400, illustrating the filling and flushing of the cache to get below the stipulated threshold, according to an embodiment of the present invention.

With this logic, the Liquidity Provider can choose to flush the cache to just below the range of the stipulated threshold when the threshold is breached (1402).

For example, assume a RATS cache for Liquidity Provider A is as follows:

| Order | | | CCY | Buy/ | Trade | | FX | Value | Foreign |
|---|---|---|---|---|---|---|---|---|---|
| No. | Trade Date | Time | Pair | Sell | Amount | CCY | Rate | Date | Amt. |
| 1 | 2010 Nov. 02 | 09:30:01.253 | USDJPY | BUY | 26571600 | JPY | 80.52 | SPOT | 330000 |
| 2 | 2010 Nov. 02 | 09:30:01.654 | USDJPY | BUY | 8054000 | JPY | 80.54 | SPOT | 100000 |
| 3 | 2010 Nov. 02 | 09:30:02.2555 | USDJPY | BUY | 24153000 | JPY | 80.51 | SPOT | 300000 |
| 4 | 2010 Nov. 02 | 09:30:02.45 | USDJPY | BUY | 40260000 | JPY | 80.52 | SPOT | 500000 |
| 5 | 2010 Nov. 02 | 09:30:03.0001 | USDJPY | BUY | 32252265 | JPY | 80.53 | SPOT | 400500 |

The RATS system sums up all the transactions to obtain the gross open position for each currency pair. The gross open position is used to subtract combination of trades that advantageously results in a position just below the threshold.

In the example above, the calculated gross open position for USDJPY is USD 1,630,500. With this gross amount, there are 5 combinations that bring the gross open position to just below the range of the threshold.

### Gross Open Position−(Order Number n . . . )=Subtracted Result of Each Combination

Combination 1: 1630500−500000−330000=800500

Combination 2: 1630500−500000−300000=830500

Combination 3: 1630500−400500−330000=900000

Combination 4: 1630500−400500−300000=930000

Combination 5: 1630500−330000−300000−100000=900500

The combination nearest to the threshold is derived by applying the following formula, with the closest match being 0%;

$$( 2 )$$

$$\frac{Threshold - ( Subtracted Result of Each Combination )}{Threshold} \times 100 \%$$

Here, combination 4 (comprising orders 5 and 3) is the closest match as it is just below the stipulated threshold. The RATS system sends a single VWAP ticket/notification 1406 to the Liquidity Provider using the trades of Combination 4.

| Trade Date | CCY Pair | Buy/Sell | Trade Amt | Trade CCY | FX Rate | Value Date |
|---|---|---|---|---|---|---|
| 2010 Nov. 02 | USDJPY | BUY | 56405265 | JPY | 80.5214347 | SPOT |

The orders 5 and 3 are flushed out 604 from the RATS Cache.

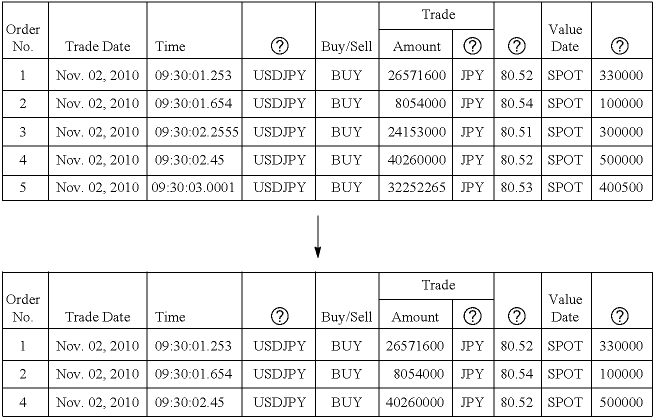

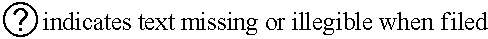

A Time-Based Trigger logic allows Liquidity Providers to set a time interval in receiving a ticket/notification for any currency pair in the long or short position. The Liquidity Providers can adjust the time interval for each trigger at any point of time through the GUI made available to them. Once the Time Interval is triggered, an aggregation or netting is done on the trades and a ticket is sent to the Liquidity Providers. Advantages of a Time-Based Trigger Logic include the minimization of operational handling costs but disadvantages include the untimely monitoring on FX exposure and counterparty risks. This logic may be used in conjunction with the Aggregated Threshold Trigger or Manual Flushing logic. If Time Based Trigger Logic is implemented with the Aggregated Threshold Trigger Logic, the timer is reset if the Threshold is triggered.

When a “BUY” or “SELL” order is filled, the details of the transaction are stored in RATS cache (“bucket”). The Liquidity Provider's stipulated Time Interval Trigger is checked with reference to the M-DAQ system time. Once the Time Interval is triggered, the cache is flushed and a ticket/notification is sent to the Liquidity Provider to inform them on the position. Otherwise, the M-DAQ system continues to monitor the Liquidity Provider's FX position within the Time Interval.

The RATS system also advantageously provides the Liquidity Provider with the option as to how they would like to receive the ticket/notification:
Aggregated basis (Total long position and Total short position) which sends one ticket for the Long position and one ticket for the Short position for a currency pair.
Netted basis (Net position between Long and Short Position) which sends a single ticket/notification for a currency pair.

For example, a US based investor decides to invest in a Singapore Stock listed in Singapore Stock Exchange by buying 100,000 shares @ USD 2.68/share. The investor inputs the “Buy” order in his own preferred currency (USD). This order is converted to the currency in which the securities are traded in (SGD). The equity order in terms of the local currency is sent to Exchange and the FX transaction is undertaken by the Liquidity Providers.

In this example, assume that for the USD/SGD currency pair, only one Liquidity Provider, A, offers a bid of 1.31 and chooses a Time Based Trigger notification with an interval of 20 seconds. Accordingly, the USD is converted to JPY based on the best rate available, which in this case is 1.31. i.e.: (USD 2.68*100,000 Securities)*1.31=SGD 351,080

Subsequently, multiple trades are transacted and their details entered in the RATS cache:

| Order | | | CCY | Buy/ | Trade | | FX | Value | Foreign |
|---|---|---|---|---|---|---|---|---|---|
| No. | Trade Date | Time | Pair | Sell | Amount | CCY | Rate | Date | Amt. |
| 1 | 2010 Nov. 02 | 09:00:00.854 | USDSGD | BUY | 351080 | SGD | 1.31 | SPOT | 268000 |
| 2 | 2010 Nov. 02 | 09:00:01.855 | USDSGD | BUY | 225000 | SGD | 1.29 | SPOT | 174418.61 |
| 3 | 2010 Nov. 02 | 09:00:05.674 | USDSGD | SELL | 100000 | SGD | 1.33 | SPOT | 75187.97 |
| 4 | 2010 Nov. 02 | 09:00:10.17 | USDSGD | BUY | 150500 | SGD | 1.32 | SPOT | 114015.16 |
| 5 | 2010 Nov. 02 | 09:00:13.52 | USDSGD | SELL | 20500 | SGD | 1.32 | SPOT | 15530.31 |
| 6 | 2010 Nov. 02 | 09:00:19.1123 | USDSGD | BUY | 55000 | SGD | 1.33 | SPOT | 41353.39 |
| 7 | 2010 Nov. 02 | 09:00:21.1123 | USDSGD | BUY | 55000 | SGD | 1.33 | SPOT | 41353.39 |
| 8 | 2010 Nov. 02 | 09:00:21.12 | USDSGD | SELL | 70000 | SGD | 1.34 | SPOT | 52238.81 |

A ticket/notification is sent to the Liquidity Provider at an interval of 20 seconds. The RATS system checks the system time for each trade, aggregates or nets the trades within the time interval, and sends a ticket/notification to the Liquidity Provider.

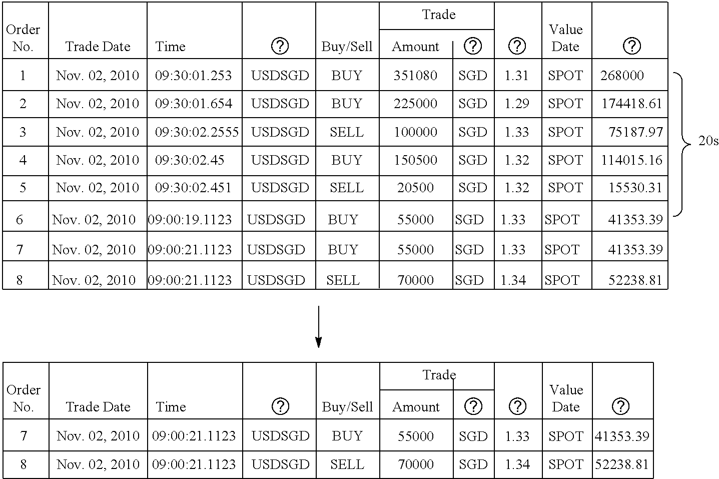

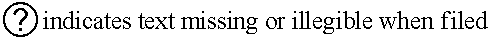

### Ticket/Notification to Liquidity Provider A:

| Trade Date | CCY Pair | Buy/Sell | Trade Amt | Trade CCY | FX Rate | Value Date |
|---|---|---|---|---|---|---|
| 2010 Nov. 02 | USDSGD | BUY | 781580 | SGD | 1.3075 | SPOT |
| 2010 Nov. 02 | USDSGD | SELL | 120500 | SGD | 1.3283 | SPOT |

A Manual Flushing logic allows Liquidity Providers to monitor their exposure to FX risks to their own discrete. For example, if a Liquidity Provider has an adverse view on a certain currency pair, it can clear its position by a “Manual Flush” of one or more currency caches (“buckets”) through the GUI. This logic may used in conjunction with the Aggregated Threshold Trigger or Time-Based Trigger Logic. Advantages of this logic include the timely monitoring of risk. However, operational handling costs are incurred in monitoring the GUI.

When a “BUY” or “SELL” order is filled, the details of the transaction are stored in RATS cache (“bucket”). No automatic flushing of currency bucket is carried out.

In a No Rules Applied Logic, no aggregation or netting is done on the trades. The Liquidity Provider receives one ticket/notification for each individual transaction. The threshold and time-trigger rule is set to “0” to allow a seamless flow without going through any logic. Advantages of this logic include relatively easy tracing and monitoring for each transaction, but results in a capacity issue when sending numerous tickets and increased costs due to operation handling. This logic may not be used in conjunction with any of the above logics.

In a further embodiment of the present invention, when Liquidity Providers provide firm streaming rates to users, a Stop Loss/Opportunity Gain (SLOG) Re-pricer advantageously monitors FX rates and calculates a SLOG-Ceiling and SLOG-Floor Trigger for each incoming order. When the current FX rate hits either a SLOG-Ceiling or SLOG-Floor trigger, the SLOG re-prices the original orders.

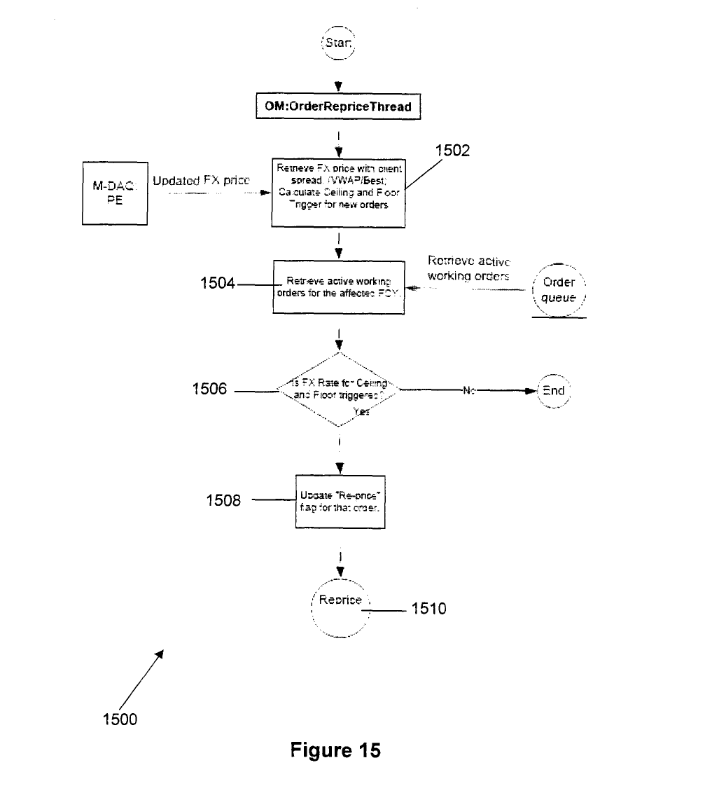

FIG. 15 is a flowchart, designated generally as reference numeral 1500, illustrating the workflow in a foreign stock investment trade using a multi-denomination automated quotation (M-DAQ) platform comprising a Stop Loss/Opportunity Gain (SLOG) Re-pricer, according to an embodiment of the present invention. During a foreign stock investment trade, a foreign currency limit order can be placed. One or more Liquidity Providers provide firm streaming rates to users. At step 1502, the best bid/ask rate is obtained from the one or more Liquidity Providers. At the same time, the Stop Loss/Opportunity Gain (SLOG) Re-pricer calculates a SLOG-Ceiling and SLOG-Floor Trigger for each incoming limit order. At step 1504, active working orders for the affected foreign currency (FCY) are retrieved. At step 1506, the SLOG Re-pricer checks whether or not the current FX rate hits either the SLOG-Ceiling or SLOG-Floor Trigger. If the current FX rate hits either trigger, the SLOG re-pricer updates and re-prices the original orders at steps 1508 and 1510 respectively. The M-DAQ platform with the SLOG re-pricer advantageously retains an investor's initial capital outlay or intended returns by re-pricing the orders in real time.

1) If the FX Rate moves in the favour of the investor inputting a Buy Order, the intended Buy Price is re-priced at a higher local price, which gives the investor a better chance for a successful execution. This is known as “Opportunity Gain”.
2) If the FX Rate moves against the investor inputting a Buy Order, the intended Buy Price is re-priced at a lower local price, which prevents the investor from paying more than intended for a particular transaction. This is known as “Stop loss”.
3) On the contrary, if the FX Rate moves in the favour of the investor inputting a Sell Order, the intended Sell Price is re-priced at a lower local price which gives the investor a better chance for a successful execution. This is known as “Opportunity Gain”.
4) If the FX Rate moves against the investor inputting a Sell Order, the intended Sell Price is re-priced at a higher local price which prevents the investor from getting less return than expected. This is known as “Stop loss”.
Further, the SLOG Re-pricer adopts a “No Worse Than (NWT)” Rule to safeguard an investor's interest, wherein:
For Buy Orders, the converted local currency (LCY) price in which the securities are traded in is rounded down to the nearest tick size as stated by the National Exchange.
For Sell Orders, the converted local currency (LCY) price in which the securities are traded in is rounded up to the nearest tick size as stated by the National Exchange.

### Example 1

### Stop Loss/Opportunity Gain for “Buy” Order (CCY1/CCY2 where CCY1 is FCY)

Assume the Best Rate taken from the Liquidity Provider at a point in time is:

| BID | ASK |
|---|---|
| 84.552 | 84.573 |

If a US based investor decides to invest in a Japanese Stock listed in the Tokyo Stock Exchange and Buys 1,000 shares @ USD 29.51/share, the Order input is:

| Symbol | Buy/Sell | Order Type | Qty | FCY Price |
|---|---|---|---|---|
| Stock A | B | New | 1,000 | 29.51 |

Using the Best Rate from the Liquidity Provider, the order is converted into the LCY:

| Symbol | Buy/Sell | Order Type | Qty | LCY Price | Adj. LCY Price |
|---|---|---|---|---|---|
| Stock A | B | New | 1,000 | 2495.13 | 2495 |

When the SLOG No Worse Than (NWT) Rule is applied, the LCY Price of Yen 2495.13 is rounded down to Yen 2495. Assuming the Toyko Stock Exchange does not accept orders in decimal places, the converted and adjusted order of Yen 2495 is placed in the Tokyo Stock Exchange Order Book.

The SLOG Re-pricer further calculates the SLOG-Ceiling Trigger and SLOG-Floor Trigger which can trigger the re-pricing.

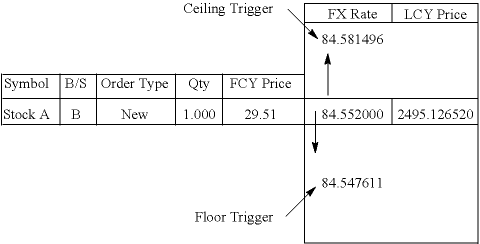

The SLOG-Ceiling Trigger of a Buy Order is the Opportunity Gain for an investor. If the FX Rate moves in the investor's favour and is greater than 84.581496, the initial Buy Order of USD 29.51 is re-priced at Yen 2496 with the NWT Rule.

The SLOG-Floor Trigger of a Buy Order is the Stop Loss for an investor. If the FX Rate moves against the investor and is less than 84.547611, the initial Buy Order of USD 29.51 is re-priced at Yen 2494 with the NWT Rule.

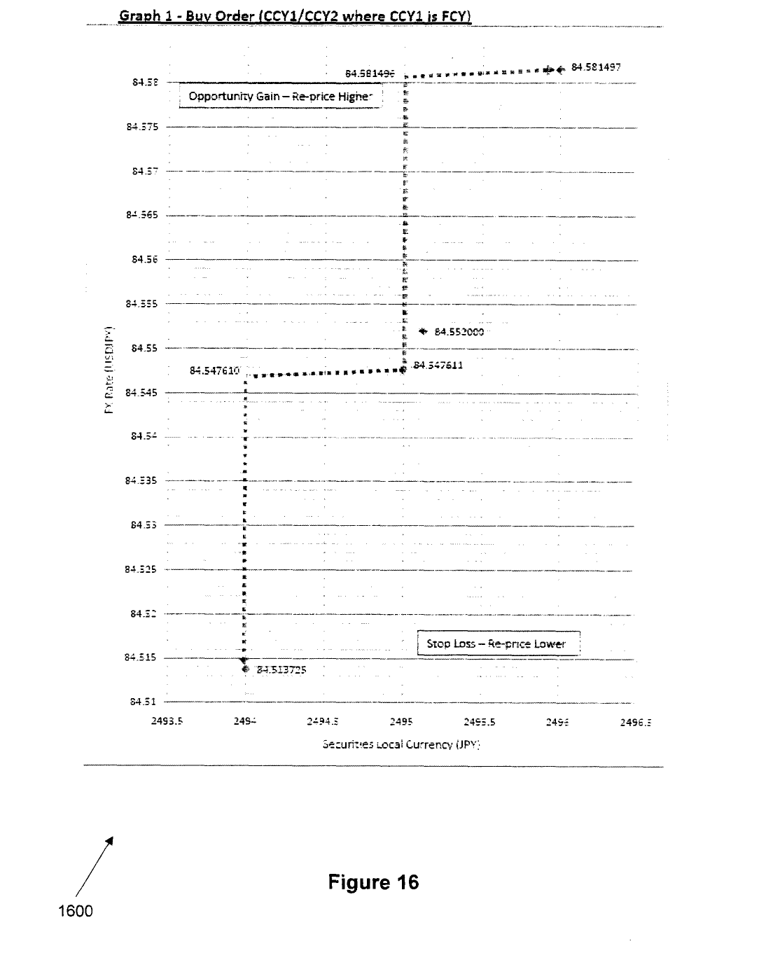

FIG. 16 is a chart, designated generally as reference numeral 1600, illustrating the re-pricing of a buy order depending on fluctuations of the FX rate, as described above, according to an embodiment of the present invention.

### Example 2

### Stop Loss/Opportunity Gain for “Sell” Order (CCY1/CCY2 where CCY1 is FCY)

Assume the Best Rate taken from the Liquidity Provider at a point in time is:

| BID | ASK |
|---|---|
| 84.565 | 84.575 |

If a US based investor decides to invest in a Japanese Stock listed in the Tokyo Stock Exchange and Sells 1,000 shares @ USD 30/share, the Order input is:

| Symbol | Buy/Sell | Order Type | Qty | FCY Price |
|---|---|---|---|---|
| Stock A | S | New | 1,000 | 30 |

Using the Best Rate from the Liquidity Provider, the order is converted into the LCY:

| Symbol | Buy/Sell | Order Type | Qty | LCY Price | Adj. LCY Price |
|---|---|---|---|---|---|
| Stock A | S | New | 1,000 | 2537.25 | 2538 |

When the SLOG No Worse Than (NWT) Rule is applied, the LCY Price of Yen 2537.25 is rounded up to Yen 2538. Assuming the Toyko Stock Exchange does not accept orders in decimal places, the converted and adjusted order of Yen 2538 is placed in the Tokyo Stock Exchange Order Book.

The SLOG Re-pricer further calculates the Ceiling Trigger and Floor Trigger which can trigger the re-pricing.

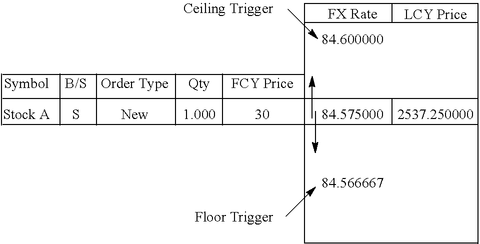

The SLOG-Floor Trigger of a Sell Order is the Opportunity Gain for an investor. If the FX Rate moves in the investor's favour and is less than the rate of 84.566667, the initial Sell Order of USD 30 is re-priced at Yen 2537 with the NWT Rule.

The SLOG-Ceiling Trigger of a Sell Order is the Stop Loss for an investor. If the FX Rate moves against the investor and is greater than the rate of 84.6, the initial Sell Order of USD 30 is re-priced at Yen 2539 with the NWT Rule.

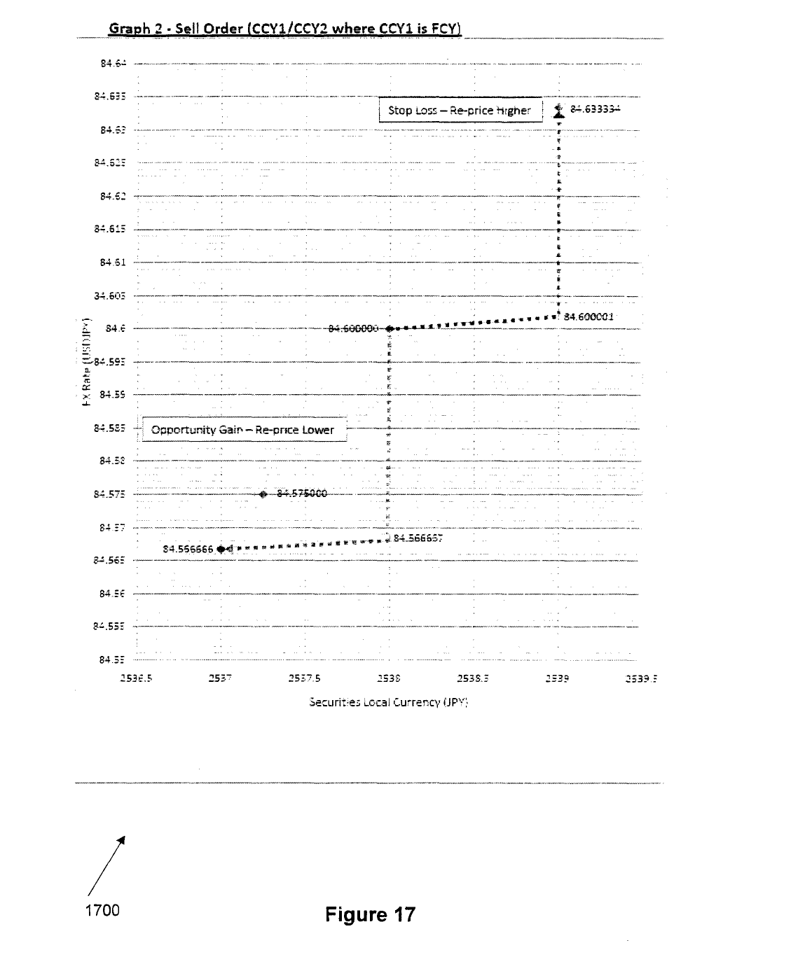

FIG. 17 is a chart, designated generally as reference numeral 1700, illustrating the re-pricing of a sell order depending on fluctuations of the FX rate, as described above, according to an embodiment of the present invention.

### Example 3

### Stop Loss/Opportunity Gain for “Buy” Order (CCY1/CCY2 where CCY2 is FCY)

Assume the Best Rate taken from the Liquidity Provider at a point in time is:

| BID | ASK |
|---|---|
| 1.3953 | 1.3954 |

If a US based investor decides to invest in a Europe Stock listed in the London Stock Exchange and Buys 1,000 shares @ USD 24/share, the Order input is:

| Symbol | Buy/Sell | Order Type | Qty | FCY Price |
|---|---|---|---|---|
| Stock A | B | New | 1,000 | 24 |

Using the Best Rate from the Liquidity Provider, the order is converted into the LCY:

| Symbol | Buy/Sell | Order Type | Qty | LCY Price | Adj. LCY Price |
|---|---|---|---|---|---|
| Stock A | B | New | 1,000 | 17.1994 | 17 |

When the SLOG No Worse Than (NWT) Rule is applied, the LCY Price of EUR 17.1994 is rounded down to EUR 17. Assuming the London Stock Exchange does not accept orders in decimal places, the converted and adjusted order of EUR 17 is placed in the London Stock Exchange Order Book.

The SLOG Re-pricer further calculates the Ceiling Trigger and Floor Trigger which can trigger the re-pricing.

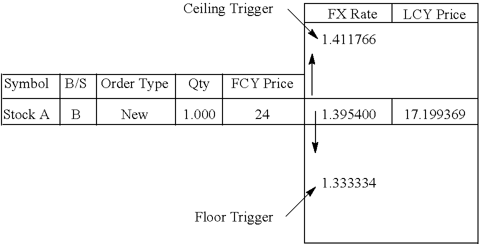

The SLOG-Floor Trigger of a Buy Order is the Opportunity Gain for an investor. If the FX Rate moves in the investor's favour and is less than the rate of 1.333334, the initial Buy Order of USD 24 is re-priced at EUR 18 with the NWT Rule.

The SLOG-Ceiling Trigger of a Buy Order is the Stop Loss for an investor. If the FX Rate moves against the investor and is more than the rate of 1.411766, the initial Buy Order of USD 24 is re-priced at EUR 16 with the NWT Rule.

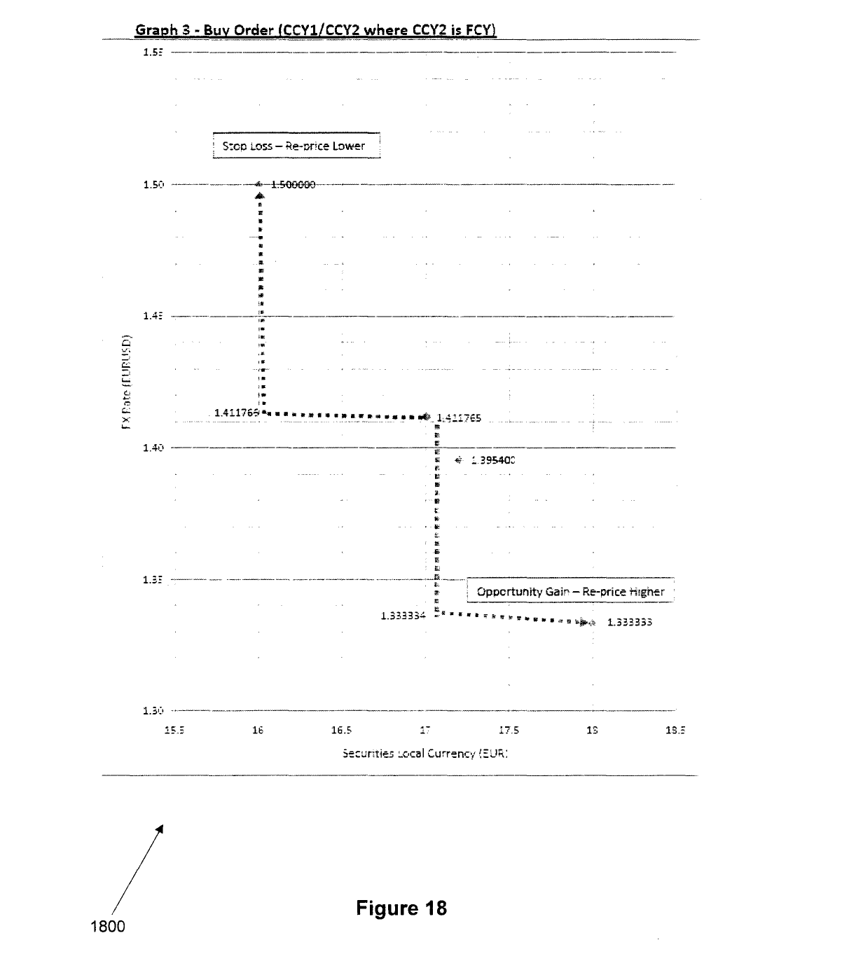

FIG. 18 is a chart, designated generally as reference numeral 1800, illustrating the re-pricing of a buy order depending on fluctuations of the FX rate, as described above, according to an embodiment of the present invention.

### Example 4

### Stop Loss/Opportunity Gain for “Sell” Order (CCY1/CCY2 where CCY2 is FCY)

Assume the Best Rate taken from the Liquidity Provider at a point in time is:

| BID | ASK |
|---|---|
| 1.3942 | 1.3944 |

If a US based investor decides to invest in a Europe Stock listed in the London Stock Exchange and Sells 1,000 shares @ USD 30/share, the Order input is:

| Symbol | Buy/Sell | Order Type | Qty | FCY Price |
|---|---|---|---|---|
| Stock A | S | New | 1,000 | 30 |

Using the Best Rate from the Liquidity Provider, the order is converted into the LCY:

| Symbol | Buy/Sell | Order Type | Qty | LCY Price | Adj. LCY Price |
|---|---|---|---|---|---|
| Stock A | S | New | 1,000 | 21.5177 | 22 |

When the SLOG No Worse Than (NWT) Rule is applied, the LCY Price of EUR 21.5177 is rounded up to EUR 22. Assuming the London Stock Exchange does not accept orders in decimal places, the converted and adjusted order of EUR 22 is placed in the London Stock Exchange Order Book.

The SLOG Re-pricer further calculates the Ceiling Trigger and Floor Trigger which can trigger the re-pricing.

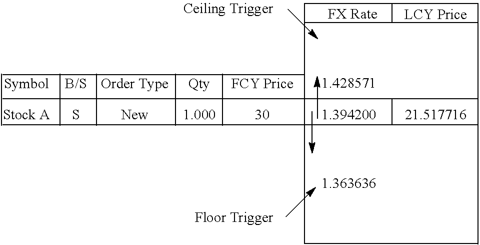

The SLOG-Ceiling Trigger of a Sell Order is the Opportunity Gain for an investor. If the FX Rate moves in the investor's favour and is greater than the rate of 1.428571, the initial Sell Order of USD 30 is re-priced at EUR 21 with the NWT Rule.

The SLOG-Floor Trigger of a Sell Order is the Stop Loss for an investor. If the FX Rate moves against the investor which is less than the rate of 1.363636, the initial Sell Order of USD 24 is re-priced at EUR 23 with the NWT Rule.

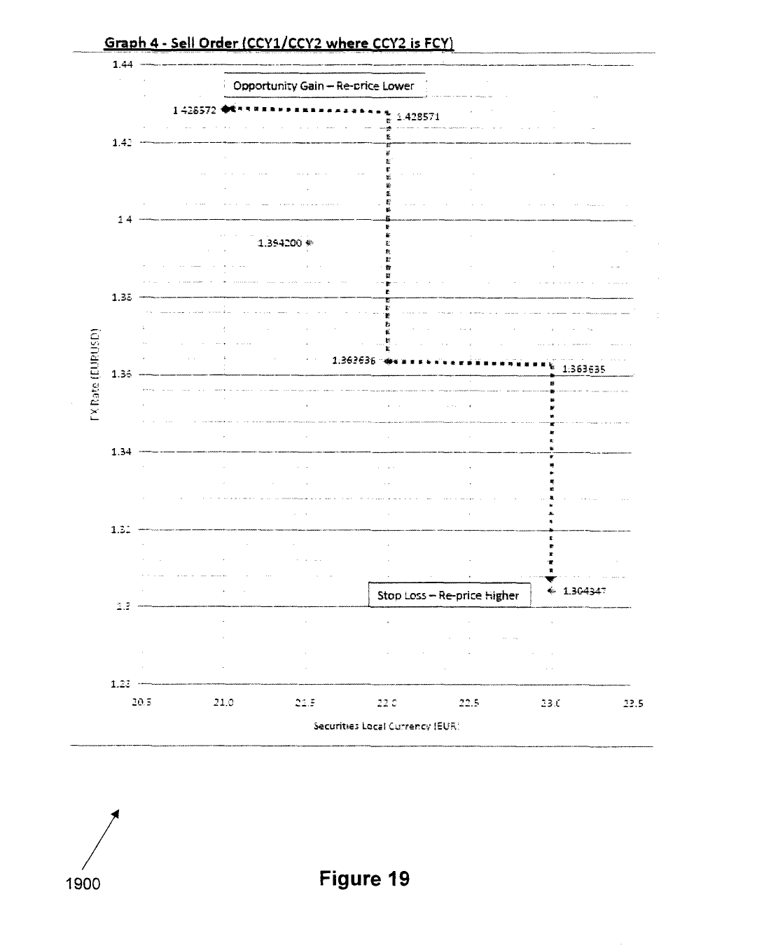

FIG. 19 is a chart, designated generally as reference numeral 1900, illustrating the re-pricing of a buy order depending on fluctuations of the FX rate, as described above, according to an embodiment of the present invention.

According to another embodiment of the present invention, the plurality of fixed bid/offer rates received from Liquidity Providers (LPs) are sorted in terms of price priority and time priority. The best available rate is allocated to a security trade for placement and re-pricing. A Pricing Engine (PE) monitors incoming FX prices and streams the best rates for securities FX conversion through a Possibility of Transaction (POT) function.

In an example embodiment, the POT function is configured to apply a set of rules, wherein:
a. All incoming FX prices are streamed to a consolidated table managed by the PE
b. The PE sorts the BID FX prices in descending order with the highest price as the best price. If the LPs stream the same competitive price, they are sorted in terms of time priority.
c. The PE sorts the ASK FX prices in ascending order with the lowest price as the best price. If the LPs stream the same competitive price, they are sorted in terms of time priority

In order to advantageously prevent slippages to the liquidity providers, the POT function is configured to implement various solutions to derive and allocate the FX rate, which are described in detail as follows.

The first solution adopted through the POT function is the Liquidity Provider Level Solution, which allows the National Exchange to determine the level of FX prices to be used through a Graphical User Interface (GUI).

The VWAP FX price is derived using the following formula:

$$( 3 )$$

$$VWAP FX Price = \frac{Sum of Value from “ X ” chosen level}{Sum of Liquidity from “ X ” chosen level} \qquad$$

where “X” is the level of FX prices chosen by the National Exchange.

For example, the following rates are received and sorted in the Pricing Engine with Price and Time priority:

| Quote Date | Quote Time | LP | CCY | BID/ASK | FX Rate | Liquidity | Value |
|---|---|---|---|---|---|---|---|
| 2011 Jan. 28 | 9:15:23.123 | 1 | USDJPY | BID | 80.245 | 1,000,000 | 80245000 |
| 2011 Jan. 28 | 9:15:23.123 | 2 | USDJPY | BID | 80.245 | 1,000,000 | 80245000 |
| 2011 Jan. 30 | 9:15:25.225 | 3 | USDJPY | BID | 80.243 | 1,500,000 | 120364500 |
| 2011 Jan. 31 | 9:15:26.126 | 1 | USDJPY | BID | 80.240 | 1,500,000 | 120360000 |
| 2011 Feb. 01 | 9:15:27.127 | 4 | USDJPY | BID | 80.235 | 2,000,000 | 160470000 |

### Assuming “X”=2:

| Quote Date | Quote Time | LP | CCY | BID/ASK | FX Rate | Liquidity | Value |
|---|---|---|---|---|---|---|---|
| 2011 Jan. 28 | 9:15:23.123 | 1 | USDJPY | BID | 80.245 | 1,000,000 | 80245000 |
| 2011 Jan. 28 | 9:15:23.123 | 2 | USDJPY | BID | 80.245 | 1,000,000 | 80245000 |
| 2011 Jan. 30 | 9:15:25.225 | 3 | USDJPY | BID | 80.243 | 1,500,000 | 120364500 |
| 2011 Jan. 31 | 9:15:26.126 | 1 | USDJPY | BID | 80.240 | 1,500,000 | 120360000 |
| 2011 Feb. 01 | 9:15:27.127 | 4 | USDJPY | BID | 80.235 | 2,000,000 | 160470000 |

$$\begin{matrix}VWAP FX Price = ( 80245000 + 8024500 ) / ( 1000000 + 1000000 ) \\ = 160490000 / 2000000 \\ = 80.245\end{matrix}$$

This FX price is streamed to the Order Manager (SLOG) for pricing and re-pricing. The liquidity of each FX price is monitored in real time and if there are any changes to the liquidity or FX price, the VWAP FX price is re-calculated and sent to the Order Manager.

In the second solution, through the Graphical User Interface (GUI) offered to the National Exchange, the expected trade amount is entered into the system. With automation rules in place, the POT carves out the FX prices enough to cover the trade amount entered. A VWAP price is then calculated in real time.

The VWAP FX price is derived using the following formula:

$$VWAP FX Price = \frac{Sum of Value from “ X ” chosen level based on “ y ”}{Sum of Liquidity from “ X ” chosen level based on “ y ”} \qquad ( 4 )$$

“X” is the level of FX prices chosen by the PE

“y” is the trade volume input by the National Exchange

For example, the following rates are received and sorted in the Pricing Engine with Price and Time priority:

| Quote Date | Quote Time | LP | CCY | BID/ASK | FX Rate | Liquidity | Value |
|---|---|---|---|---|---|---|---|
| 2011 Jan. 28 | 9:15:23 123 | 2 | USDJPY | ASK | 80.254 | 1,000,000 | 80254000 |
| 2011 Jan. 28 | 9:15:25.225 | 3 | USDJPY | ASK | 80.258 | 1,000,000 | 80258000 |
| 2011 Jan. 30 | 9:15:25.225 | 1 | USDJPY | ASK | 80.258 | 1,000,000 | 80258000 |
| 2011 Jan. 31 | 9:15:25.225 | 4 | USDJPY | ASK | 80.600 | 2,000,000 | 161200000 |
| 2011 Feb. 01 | 9:15:26.127 | 2 | USDJPY | ASK | 80.605 | 2,000,000 | 161210000 |

Assuming y=200,000,000 (i.e. 200,000,000 was the forecast local currency needed to cover the trades at any time), the POT algorithm calculates the VWAP FX price based on the local currency needed and its availability.

| Quote Date | Quote Time | LP | CCY | BID/ASK | FX Rate | Liquidity | Value |
|---|---|---|---|---|---|---|---|
| 2011 Jan. 28 | 9:15:23.123 | 2 | USDJPY | ASK | 80.254 | 1,000,000 | 80254000 |
| 2011 Jan. 28 | 9:15:25.225 | 3 | USDJPY | ASK | 80.258 | 1,000,000 | 80258000 |
| 2011 Jan. 30 | 9:15:25.225 | 1 | USDJPY | ASK | 80.258 | 1,000,000 | 80258000 |
| 2011 Jan. 31 | 9:15:25.225 | 4 | USDJPY | ASK | 80.600 | 2,000,000 | 161200000 |
| 2011 Feb. 01 | 9:15:26.127 | 2 | USDJPY | ASK | 80.605 | 2,000,000 | 161210000 |

As the best 3 FX rates have sufficient liquidity to cover 200,000,000, the FX VWAP rate is calculated based on these rates.

$$\begin{matrix}VWAP FX Price = \frac{( 80254000 + 80258000 + 80258000 )}{( 1000000 + 1000000 + 1000000 )} \\ = 240770000 / 3000000 \\ = 80.25666667\end{matrix}$$

This FX price is streamed to the Order Manager (SLOG) for pricing and re-pricing. The liquidity of each FX price is monitored in real time and if there are any changes to the liquidity or FX price, the VWAP FX price is re-calculated and sent to the Order Manager.

The third solution of deriving a VWAP rate is based on “market momentum” by using a Transaction Ratio calculated in a stated time interval. This is to advantageously keep track of the trade amount likely to be transacted and deriving a real time VWAP FX price.

The procedure is as follows:
1. Obtain total transacted value through M-DAQ of past “x” duration (days/hours)
2. Obtain total value of orders submitted through M-DAQ of past “x” duration (days/hours)
3. Obtain Transaction Ratio by Total Transacted Value/Total Value of orders of each day using Simple average or Weighted Average.

| | |
|---|---|
| i. Obtain total transacted value through M-DAQ | n |
| ii. Obtain total value of orders submitted through M-DAQ | N |
| iii. Obtain Transaction Ratio | n/N |

4. Obtain the Transaction Ratio in a stipulated time interval.
5. M-DAQ monitors the current orders real time and carves out the liquidity needed to cover this amount. From this amount, a VWAP FX price can be derived.
   For example, for a start of a new trading day, the ratio of stock A is calculated based on the average of the last 5 days opening ½ hr estimated transaction possibility.

| Day | Ratio |
|---|---|
| n-5 | 0.871 |
| n-4 | 0.752 |
| n-3 | 0.934 |
| n-2 | 0.850 |
| n-1 | 0.650 |

Simple average: (0.871+0.752+0.934+0.85+0.65)/5=0.8114

Weighted average:

$$\frac{0.65 + 0.85 * a + 0.934 * {a}^{2} + 0.752 * {a}^{3} + 0.871 * {a}^{4}}{1 + a + {a}^{2} + {a}^{3} + {a}^{4}} , ( 0 < a < 1 )$$

If a=0.8, Weighted Average=0.7893

Suppose we use the simple average:
i. Assuming the order input through M-DAQ at the start of trading day is 23.50 Mil [inventor—please confirm that “23.50” should be “12.54” instead] worth of orders.
   Applying Transaction Ratio to the total orders input, there is a high chance that 10.175 Mil worth of orders could be transacted. (0.8114*12.54=10.175)
ii. From the consolidated FX table, the highlighted rows comprises the liquidity needed to cover the potential transaction as stated by the Transaction Ratio (i.e. 10.175 Mil).

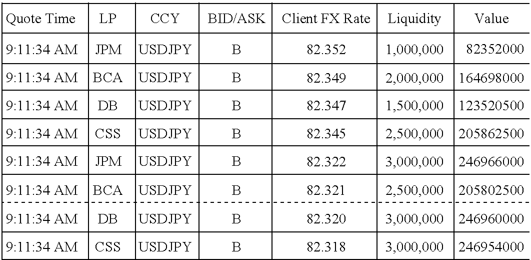

iii. VWAP: Sum of Value/Sum of liquidity=82.33612
   The derived VWAP is streamed to Order Manager (OM) and Market Manager (MM).

In the fourth solution, by assigning groups to different factors, the possibility of a particular trade being transacted can be determined from the various factors and a better rate can be allocated.

Each order is assigned with different rates based on their probability of execution, and the orders are first sorted based on the factors that affect the possibility of order execution, for example, stock volatility, tick distance, etc.

The procedure is as follows:

1. Identify a factor that shows how likely an order placed is executed

2. Maintain a Grouping table determining groups for different factors

3. Based on the grouping for each order, classify that category of execution

4. Orders with a better chance of execution are provided with better rates

For example, “tick distance” is chosen as the only factor to measure the possibility of execution. A shorter distance indicates a high possibility and hence is assigned a higher weight and is provided with a better FX rate. This means that for a security trading at USD 9.50, an input order to buy at USD 9.45 has a higher chance of execution compared to an input order to buy at USD 9.40.

Using the following rules for the factor “Tick Distance”:

Buy Order
Tick Distance =
(Last Trade Price − Limit Order Input)/Tick
Size
Sell Order
Tick Distance =
(Limit Order input − Last Trade Price)/Tick
Size

Tick Distance Grouping Table

| No. | Tick Distance | Group |
|---|---|---|
| a | 1~3 | 1 |
| b | 4~7 | 2 |
| c | >10 | 3 |

### Investor A

Input Buy Order @ USD 10.45 worth 4.5 mil

### Tick Distance=[(10.50−10.45)/0.05]=1

Group allocated: 1

### Investor B

Input Buy Order @ USD 10.25 worth 3 mil

### Tick Distance=[(10.50−10.25)/0.05]=5

Group allocated: 2

### Investor C

Input Sell Order @ USD 10.60 worth 2.5 mil

### Tick Distance=[(10.70−10.50)/0.05]=4

Group allocated: 2
The liquidity needed is carved out based on the grouping via automation, using the solution described above.

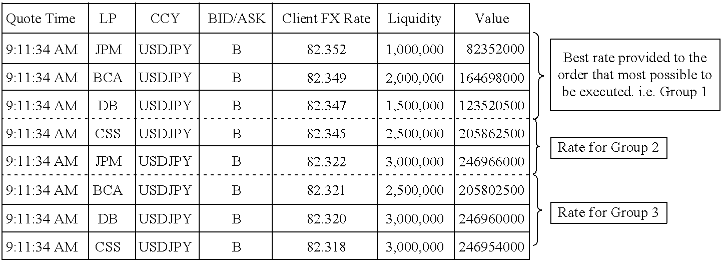

When 2 factors are chosen to measure the possibility of execution for a particular security, 2 different approaches may be used.

In the first approach, the likely outcomes are further classified into category of execution. Adopting the same methodology as per single factor, liquidity needed is carved out via automation.

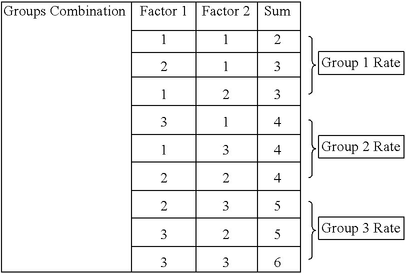

The second approach involves mean estimating the time taken between order placement and execution so as to get the possibility of execution before the end of the trading day.

Assuming POT using linear regression, the following formula is taken as reference and used with historical data.

Y=β₁*factor1+β₂*factor2+β₃*factor3+ . . . +ε (5)

| Component | Definition |
|---|---|
| Y | time between order placement and execution |
| ε | random variable representing all other factors |
| | that may have direct influence on the Y |
| factor | factor that has an influence on Y |
| β₁ | measures the increase in the time required |
| | attributable to one more unit of factor1 |

With the historical data, β can be determined to yield the Time factor (Y). The timing is further classified into category of execution. Adopting the same methodology as per single factor, liquidity needed is carved out via automation.

Embodiments of the present invention do not create multiple orderbooks/depth of market for a particular security. Rather, embodiments of the present invention seek to enable all orders of different currencies to “meet up” in a single physical orderbook/depth of market maintained by a National Exchange, as it is the best venue for price discovery. Furthermore, there is advantageously no dilution of liquidity. The SLOG module reprices and submits orders in local currency into the single physical orderbook/depth of market.

Advantageously, the systems and methods of embodiments of the present invention do not require changes to the current method of electronic order feeding. More particularly, no additional latency is preferably introduced to the current method when differentiating between an order in a local currency and an order in a foreign currency.

Foreign investors face considerable FX market risk between the time of placing an order for a securities trade and when the FX conversion takes place. Embodiments of the present invention advantageously reduce the uncertainty associated with the FX market risk at the time of order placing and execution on the underlying securities on the Exchange. In other words, the full profit and loss of a trade can be better known prior to the trading decision.

Currently, decisions on a securities trade is typically made with little due consideration of the underlying FX rate. With embodiments of the invention, decisions on the securities trade can now be made with full imputation of the two variables—Securities Price and FX Price. Thus the investor can properly time his entry and exit of the market.

There is a considerable cost for Listed Companies in performing multiple secondary listings in order to allow different geographical or temporal investors to trade in their securities. However, embodiments of the present invention reduce the need and cost of dual listing on different Exchanges by Listed Companies.

There is also a need to prove Best Execution by typically seeking out a minimum of X number of bid/offer prices and to ensure sufficient internal control and record keeping on this key proof of fiduciary duties which can be very resource intensive. Embodiments of the present invention provide a blended FX and Securities price provided by an Exchange, which can minimize the need to further prove Best Execution.

Retail investors currently pay on average 50-80 bps on the FX conversion done by their brokers. Institutional Fund Managers usually pay 3-5 bps spreads while the actual FX Interbank prices range from 1-2 bps. According to embodiments of the present invention, the FX liquidity providers (LPs) can stream rates close to Interbank levels and is made possible with large aggregate flows from the Exchange, elimination of credit costs associated with brokers and fund managers as counterparties, and minimizing FX ticketing cost issues faced by the LPs. Significantly better FX rates (up to a factor of 50 times) may be obtained from the implementation of the method and system according to embodiments of the present invention offering a single multibank FX wholesale price to all investors regardless of profile or trade size.

Most exchanges are predominantly reliant on domestic investors for velocity (active trading), with cross-border trades usually in the hands of institutional investors. Embodiments of the present invention may encourage a broader spectrum of international investors, which can provide diversification.

Currently, there is no timely and consolidated (country level) flow of funds information available. At present, large FX banks provide this information on an end of day basis to their selected clients and such information only reflects the currency flows as registered by the individual banks. Embodiments of the present invention may allow Central Banks to obtain near real-time information as the National Exchange is a good proxy of the overall cross-border activities in the country.

Exchanges currently face a scenario where often the only way to attract new listings is by cutting a variety of fees and having a more attractive investor base where the Price Earning (PE) Ratio can be higher than its peer Exchanges. New market access products may be needed in order to be relevant. The quoting of only local currency limits the access of the Exchange to cross border investors as it is often viewed as confusing, expensive and slow. Exchanges that deploy embodiments of the present invention can make its securities be viewed as if it was listed in other geographies without physically being there and can allow investors from overseas to trade the local securities no different from that of their own home Exchanges. This may also attract Global MNCs listed elsewhere to try a secondary listing in an Exchange which deploys embodiments of the present invention.

Embodiments of the present invention advantageously make global securities “local” and give investors more choices in their portfolio composition, removing the mental, financial and technological barriers to cross-border securities investment. In other words, investors can make trading decisions based on both stock prices (quoted in LCY) and executable LCY-cross FX rates, which can open the gates for overseas investors who aspire to participate in overseas stock markets, both as a proxy to overseas economies as well as for investors to participate in the secondary listings of foreign companies.

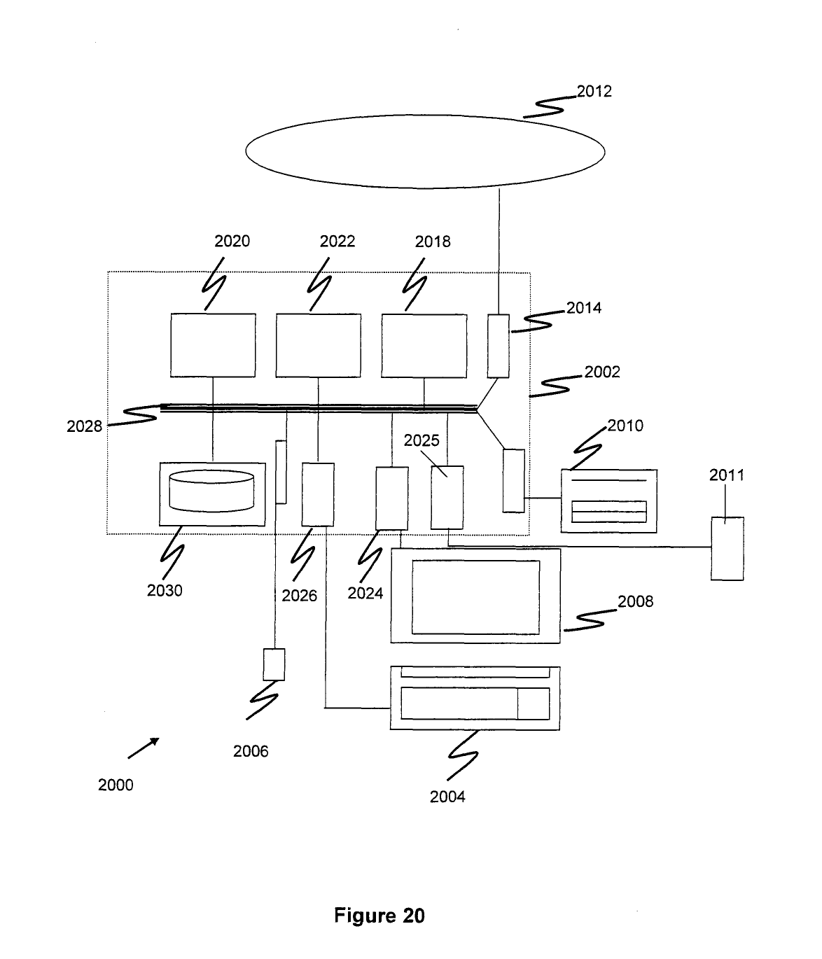

FIG. 20 is a flow chart, designated generally as reference numeral 2000, illustrating a method for trading a security in a foreign currency, according to an example embodiment of the present invention. At step 2002, FX data streamed from one or more liquidity providers is maintained in a FX pricing module. At step 2004, original trade data associated with the security in a trading currency of the security is received in a market manager module. At step 2006, converted trade data associated with the security in the foreign currency is automatically generated in the market manager module. The market manager module automatically generates the converted trade data based on an FX rate provided by the FX pricing module.

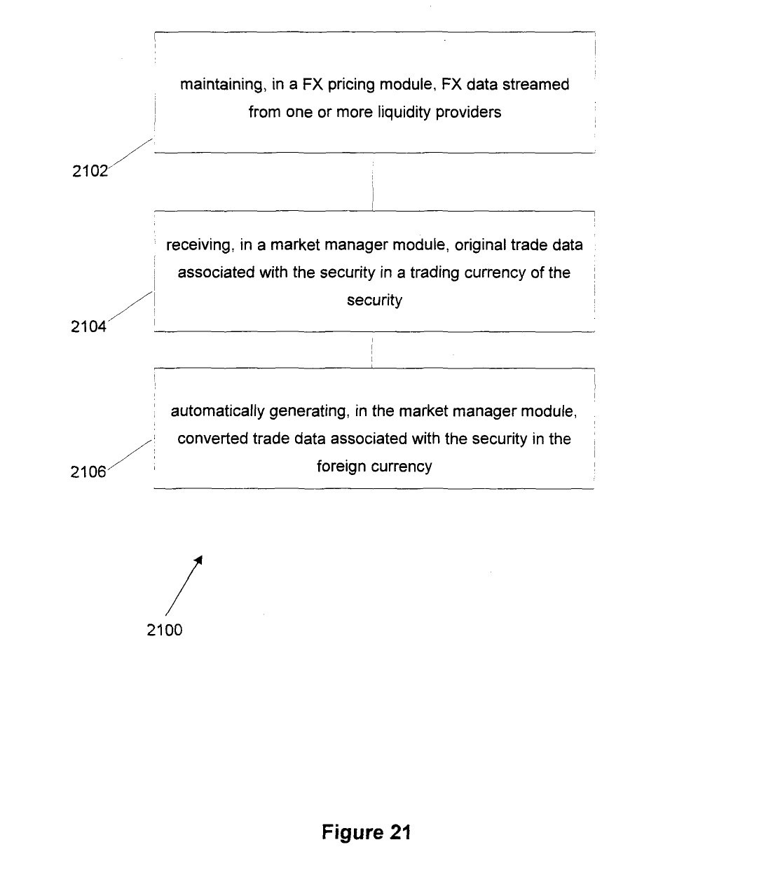

The method and system of the example embodiment can be implemented on a computer system 2100, schematically shown in FIG. 21. It may be implemented as software, such as a computer program being executed within the computer system 2100, and instructing the computer system 2100 to conduct the method of the example embodiment.

The computer system 2100 comprises a computer module 2102, input modules such as a keyboard 2104 and mouse 2106 and a plurality of output devices such as a display 2108, and printer 2110.

The computer module 2102 is connected to a computer network 2112 via a suitable transceiver device 2114, to enable access to e.g. the Internet or other network systems such as Local Area Network (LAN) or Wide Area Network (WAN).

The computer module 2102 in the example includes a processor 2118, a Random Access Memory (RAM) 2120 and a Read Only Memory (ROM) 2122. The computer module 2102 also includes a number of Input/Output (I/O) interfaces, for example I/O interface 2124 to the display 2108, and I/O interface 2126 to the keyboard 2104.

The components of the computer module 2102 typically communicate via an interconnected bus 2128 and in a manner known to the person skilled in the relevant art.

The application program is typically supplied to the user of the computer system 2100 encoded on a data storage medium such as a CD-ROM or flash memory carrier and read utilising a corresponding data storage medium drive of a data storage device 2130. The application program is read and controlled in its execution by the processor 2118. Intermediate storage of program data maybe accomplished using RAM 2120.

It will be appreciated by a person skilled in the art that numerous variations and/or modifications may be made to the present invention as shown in the embodiments without departing from a spirit or scope of the invention as broadly described. The embodiments are, therefore, to be considered in all respects to be illustrative and not restrictive.

1. A system for trading a security in a foreign currency comprising:
an FX pricing module for maintaining FX data streamed from one or more liquidity providers;
a market manager module configured to receive original trade data associated with the security in a trading currency of the security and to generate converted trade data associated with the security in the foreign currency, wherein the market manager module generates the converted trade data based on an FX rate provided by the FX pricing module; and
an order manager module configured to instruct execution of an order for trading in the security in the foreign currency based on the converted trade data.

2. The system as claimed in claim 1, wherein the order manager module is configured to execute the order by instructing execution of a trade of the security in the trading currency.

3. The system as claimed in claim 1 or 2, wherein the order manager is configured to execute the order by instructing an FX execution manager for executing a foreign/trading currencies trade.

4. The system as claimed in claim 1, wherein the order comprises a market order identifying the security and an order quantity.

5. The system as claimed in claim 4, wherein the order further comprises an order type.

6. The system as claimed in claim 5, wherein the order manager module initiates queuing and matching of the market order in the trading currency based on a current price, and the FX execution manager executes the foreign/trading currencies trade based on the FX rate provided by the FX pricing module.

7. The system as claimed in claim 4, wherein the order comprises a limit order identifying the security, an order quantity, an order type, and a set price in the foreign currency.

8. The system as claimed in claim 7, wherein the order manager module initiates queuing and matching of the limit order in the trading currency based on a converted price from the set price in the foreign currency using the FX rate provided by the FX pricing module.

9. The system as claimed in claim 8, wherein the order manager module is configured to adjust the converted price based on an updated FX rate from the FX pricing module, and to replace the limit order with an updated limit order for queuing and matching.

10. The system as claimed in claim 8 or 9, wherein the FX execution manager executes the foreign/trading currencies trade based on the FX rate provided by the FX pricing module upon matching of the limit order.

11. The system as claimed in claim 1, further comprising an aggregation module configured to store positions held by the one or more liquidity providers,
wherein the aggregation module is configured, for each liquidity provider, to issue a single ticket based on two or more of the stored positions for said each liquidity provider.

12. The system as claimed in claim 11, wherein the aggregation module is configured to issue the single ticket if the stored positions for said each liquidity providers meet a threshold criteria.

13. The system as claimed in claim 12, wherein the threshold criteria comprises one or more of a group consisting of a threshold currency amount, and a time interval.

14. The system as claimed in claim 13, wherein the aggregation module is configured to clear all the stored positions for said each liquidity provider for issuing the single ticket.

15. The system as claimed in claim 13, wherein the aggregation module is configured to clear the stored positions for said each liquidity provider to within a range around the threshold currency amount for issuing the single ticket.

16. The system as claimed in claim 13, wherein the aggregation module is configured to clear the stored positions such that a currency amount of remaining positions is below the threshold currency amount for said each liquidity provider for issuing the single ticket.

17. The system as claimed in claim 1, further comprising a repricing module configured to reprice orders placed in the system,
wherein the repricing module is configured to reprice the orders real-time based on streaming updated information from the FX pricing module.

18. The system as claimed in claim 17, wherein the repricing module is configured to calculate a ceiling trigger and a floor trigger for triggering the repricing.

19. The system as claimed in claim 18, wherein the repricing module is configured to calculate the ceiling trigger and a floor trigger based on rounded trading currency values associated with the order.

20. The system as claimed in claim 19, wherein the repricing module is configured to calculate the ceiling trigger and a floor trigger based on next higher and next lower rounded trading currency values associated with the order.

21. The system as claimed in claim 1, further comprising a selection module configured to determine current FX data for use in the system,
wherein the selection module is configured to select the current FX data based on two or more sets of FX data streamed from the one or more liquidity providers.

22. The system as claimed in claim 21, wherein the selection module is configured to the select the current FX data based on ranked sets of FX data.

23. The system as claimed in claim 22, wherein the selection module is configured to the select the current FX data based on a volume weighted average of the two or more sets of FX data streamed from the one or more liquidity providers.

24. The system as claimed in claim 23, wherein the selection module is configured to the select the current FX data based on one or more of a group consisting of a liquidity provider logic, a trading volume logic, a transaction ratio logic, and a multi-factors based logic.

25. A method for trading a security in a foreign currency comprising:
maintaining, in a FX pricing module, FX data streamed from one or more liquidity providers;
receiving, in a market manager module, original trade data associated with the security in a trading currency of the security and automatically generating, in the market manager module, converted trade data associated with the security in the foreign currency, wherein the market manager module automatically generates the converted trade data based on an FX rate provided by the FX pricing module; and
executing, using an order manager module, an order for trading in the security in the foreign currency based on the converted trade data.

26. The method as claimed in claim 25, wherein executing the order comprises executing a trade of the security in the trading currency using the order manager module.

27. The method as claimed in claim 25 or 26, wherein executing the order comprises executing a foreign/trading currencies trade using an FX execution manager.

28. The method as claimed in claim 25, wherein the order comprises a market order identifying the security and an order quantity.

29. The method as claimed in claim 28, wherein the order further comprises an order type.

30. The method as claimed in claim 29, wherein the order manager module initiates queuing and matching of the market order in the trading currency based on a current price, and the FX execution manager executes the foreign/trading currencies trade based on the FX rate provided by the FX pricing module.

31. The method as claimed in claim 28, wherein the order comprises a limit order identifying the security, an order quantity, and an order type in the foreign currency.

32. The method as claimed in claim 31, wherein the order manager module initiates queuing and matching of the limit order in the trading currency based on a converted price from the set price in the foreign currency using the FX rate provided by the FX pricing module.

33. The method as claimed in claim 32, wherein the order manager module adjusts the converted price based on an updated FX rate from the FX pricing module, and replaces the limit order with an updated limit order for queuing and matching.

34. The method as claimed in claim 32 or 33, wherein the FX execution manager executes the foreign/trading currencies trade based on the FX rate provided by the FX pricing module upon matching of the limit order.

35. The method as claimed in claim 25, further comprising the step of storing positions held by the one or more liquidity providers using an aggregation module,
wherein a single ticket is issued for each liquidity provider based on two or more of the stored positions for said each liquidity provider.

36. The method as claimed in claim 35, wherein the single ticket is issued if the stored positions for said each liquidity providers meet a threshold criteria.

37. The method as claimed in claim 36, wherein the threshold criteria comprises one or more of a group consisting of a threshold currency amount, and a time interval.

38. The method as claimed in claim 37, further comprising the step of clearing all the stored positions for said each liquidity provider for issuing the single ticket.

39. The method as claimed in claim 37, further comprising the step of clearing the stored positions for said each liquidity provider to within a range around the threshold currency amount for issuing the single ticket.

40. The method as claimed in claim 37, further comprising the step of clearing the stored positions such that a currency amount of remaining positions is below the threshold currency amount for said each liquidity provider for issuing the single ticket.

41. The method as claimed in claim 25, further comprising the step of repricing orders placed in the order manager module, using a repricing module,
wherein the orders are repriced in real-time based on streaming updated information from the FX pricing module.

42. The method as claimed in claim 41, further comprising the step of calculating a ceiling trigger and a floor trigger for triggering the repricing.

43. The method as claimed in claim 42, further comprising the step of calculating the ceiling trigger and the floor trigger based on rounded trading currency values associated with the order.

44. The method as claimed in claim 43, further comprising the step of calculating the ceiling trigger and the floor trigger based on next higher and next lower rounded trading currency values associated with the order.

45. The method as claimed in claim 25, further comprising the step of determining current FX data for use in trading the security, using a selection module,
wherein the current FX data is selected based on two or more sets of FX data streamed from the one or more liquidity providers.

46. The method as claimed in claim 45, further comprising the step of selecting the current FX data based on ranked sets of FX data.

47. The method as claimed in claim 46, further comprising the step of selecting the current FX data based on a volume weighted average of the two or more sets of FX data streamed from the one or more liquidity providers.

48. The method as claimed in claim 47, further comprising the step of selecting the current FX data based on one or more of a group consisting of a liquidity provider logic, a trading volume logic, a transaction ratio logic, and a multi-factors based logic.

49. A data storage medium having stored thereon computer program code means for instructing a computer system to execute a method for trading a security in a foreign currency, as claimed in claim 25.
